(19) United States
(12) Patent Application Publication
(10) Pub. No.: US 2014/0156298 A1
(43) Pub. Date: Jun. 5, 2014

(54) MODULARIZATION FOR PRESCRIPTION FULFILLMENT AND ADHERENCE

(71) Applicant: MeadWestvaco Corporation, Richmond, VA (US)

(72) Inventors: Patricia CRAWFORD, Mechanicsville, VA (US); Mark MAGLIONE, Glen Allen, VA (US); Justin TOWLE, Raleigh, NC (US); Thomas R. GRINNAN, Midlothian, VA (US); Sandra J. EYERLY, McLean, VA (US); Frederick THOMPSON, Richmond, VA (US); Kenneth G. SADLER, Lake St Louis, MO (US)

(21) Appl. No.: 14/101,997

(22) Filed: Dec. 10, 2013

Related U.S. Application Data
(63) Continuation-in-part of application No. 14/097,850, filed on Dec. 5, 2013.
(60) Provisional application No. 61/733,560, filed on Dec. 5, 2012.

(51) Int. Cl. G06F 19/00

(52) U.S. Cl. CPC G06F 19/3456
USPC 705/2

(57) ABSTRACT

A modular system for facilitating fulfillment and patient adherence for multiple prescriptions. Each module is an independently executing software widget configured to perform complementary tasks in a coordinated manner to achieve specific functions as described below. Including a system module to determine a patient customize drug regimen schedule, a module to identify potential side effects and drug interactions, and other modules useful to fulfill a patient order for multiple-medications.

### RELATED APPLICATIONS

The present application is a continuation in part application of U.S. patent application Ser. No. 14/097,850 filed Dec. 5, 2013, titled “TECHNIQUES TO DELIVER MULTIPLE MEDICATIONS IN A SYNCHRONIZED MANNER,” which claims the benefit of U.S. Provisional Application No. 61/733,560 filed Dec. 5, 2012, titled “TECHNIQUES TO DELIVER MULTIPLE MEDICATIONS IN A SYNCHRONIZED MANNER,” each of which are incorporated by reference in their entirety.

### BACKGROUND

Patients frequently take multiple medications prescribed by multiple physicians. Often, there may be multiple pharmacies involved. Each of the prescriptions has its own instructions and schedule informing the patient of when and how to take each medication. It can be difficult and confusing for a patient to properly adhere to all the schedules and instructions, not to mention the effort required to obtain each individual prescription from a pharmacy.

Coordinating multiple prescriptions within the context of a complicated and dynamic health care system involves additional challenges for pharmacies and other health care organizations. Recordkeeping, reporting requirements, and continually changing patient needs must be accommodated.

The present application is directed to these and other considerations.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to deliver multiple medications in a synchronized manner to improve patient adherence. Some embodiments are particularly directed to techniques to deliver multiple medications in a synchronized manner to individual patients in a coordinated and simplified packaging scheme. In one embodiment, for example, a system may comprise a patient customization engine operative on a processor component to receive a prescription order for a period of days comprised of multiple prescriptions for a single patient. Each prescription may be representative of a medication and include prescription data. The prescriptions may be aligned to allow for filling the patient order such that all prescriptions cover the same period of days. A customization engine operative on the processor component may determine a patient customized drug regime schedule for all of the prescriptions in the prescription order over the period of days. The medications may be placed into the appropriate medication packages of a single customized package based on the PCDR schedule. The single customized package houses all of the medications for all of the eligible prescriptions for a patient over a period of days and may include one or more medication packages for each day in that period of days. One or more medication packages may be provided for one or more dosing times for one or more days within the period of days.

A patient intake engine operative on the processor component may determine an adherence assessment need for the patient. The adherence assessment may prompt the patient to respond to a set of questions. The questions may include how many pharmacies the patient uses, how many physicians prescribe medications to the patient, how many medications a patient is taking, the types of medications a patient is taking, disease state of the patient, how many visits to a hospital or emergency room that patient may have made over a recent time period. The patient responses to each question may be scored such that the greater the number of pharmacies, physicians, medications and hospital or emergency room visits result in a higher score. The sum of the scored responses may be compared to a threshold score in which a patient score above the threshold may indicate an adherence problem and/or a patient that may benefit from adherence assistance. In the alternative, certain patient responses to particular questions may trigger the system to notify the provider that this patient may benefit from the multi-med adherence system. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

The present disclosure provides modularized coordination and customization of drug regimens, especially with respect to synchronization of multiple medication prescription fulfillment and long-term patient adherence.

### BRIEF DESCRIPTION OF THE DRAWINGS

The present systems are illustrated by way of example, and not by limitation, in the figures of the accompanying drawings, wherein elements having the same reference numeral designations represent like elements throughout and wherein:

FIG. 1 illustrates a network architecture diagram of an embodiment of a system to deliver multiple medications in a synchronized manner;

FIG. 2 illustrates a block diagram of an embodiment of a system to facilitate delivery of multiple medications in a synchronized manner;

FIG. 3 illustrates an embodiment of a logic flow to deliver multiple medications in a synchronized manner;

FIG. 4 illustrates an embodiment of a logic flow to perform an adherence assessment survey;

FIG. 5 illustrates an embodiment of a computer screen image for performing an adherence assessment survey;

FIG. 6 illustrates an embodiment of a logic flow to reconcile the hours of administration (HOA) for multiple medications;

FIG. 7 illustrates an example of a customized thirty (30) day synchronized packaging solution for multiple medications;

FIG. 8 illustrates an embodiment of a computing architecture;

FIG. 9 illustrates a sample calendar format;

FIG. 10 is a high level diagram of a prescription fulfillment and adherence system in accordance with one or more embodiments;

FIG. 11 is a high level diagram of a patient adherence system in accordance with one or more embodiments;

FIG. 12 is a diagram of a method for medication coordination in accordance with one or more embodiments;

FIG. 13 is a diagram of a method for patient adherence in accordance with one or more embodiments;

FIG. 14(a)-(c) is a sample patient prescription order label;

FIG. 15(a)-(c) is another sample patient prescription order label; and

FIG. 16 is a sample patient prescription calendar.

### DETAILED DESCRIPTION

Various embodiments are generally directed to techniques to deliver multiple medications in a synchronized manner. Some embodiments are particularly directed to techniques to deliver multiple medications in a synchronized manner to individual patients in a coordinated and simplified packaging scheme.

Various embodiments may be implemented as part of a Multi-Medication Adherence Assurance (MMAA) system. The MMAA system is a customization engine which allows pharmacies and/or healthcare providers to create a customized synchronized multi-medication delivery and adherence program for customers (e.g., patients). The MMAA system may be categorized into multiple functions. There may be an adherence assessment function, a prescription synchronization function, a customization function, an inventory function, a package design function, customized labeling function, a prescription preparation function, and/or a prescription delivery function.

The adherence assessment function generally refers to a survey taken by prospective participants in the MMAA program. The survey may be conducted on-line or in person using pen and paper at a participating pharmacy location. The survey is designed to assess whether the patient's current circumstances present an adherence problem with respect to taking their medications on the customized schedule that is developed based on patient specific activities of daily living. Activities of daily living include daily self-care activities within an individual place of residence, outdoor environment or both, such as, feeding, bathing, dressing, working, walking, leisure activities, behaviors, etc.

The questions of the survey may be scored and compared to a threshold score. If the survey score indicates an adherence issue, the patient may be eligible for participation in an MMAA program. In that case, a pharmacy technician or heath care provider or the system itself may contact the patient's health care provider, physician and/or insurance provider to seek authorization for a new synchronized prescription plan or PCDR for the patient. It is to be understood that a patient may opt to participate in the program regardless of the results of the survey and that various methods of evaluating responses may be used besides scoring. The questions are filtered based on industry standards and evaluated by pharmacist. Responses that meet set criteria may be flagged for the pharmacist's attention as they may indicate the patient would benefit from the adherence program.

The synchronization function generally comprises coordinating all of the patient's current prescriptions and refills into a unified schedule such that the refill date for every prescription in the multi-med system is the same. Given the monthly calendar, the period of days that the prescriptions could be coordinated for may be 28, 29, 30, or 31 day periods. In some cases, a shorter or longer period of days is needed based on the patient's particular medications needs. In some cases, weekly alignment is best for a patient from an adherence perspective and in others 60 or 90 day periods are best for adherence. Individual prescriptions may be re-written such that re-fills and expirations are coordinated with other prescriptions in order to align the prescriptions within the selected period of days. Such alignment may assist with adherence by reducing the patient's number of trips to the pharmacy and allowing all prescriptions to be filled at once.

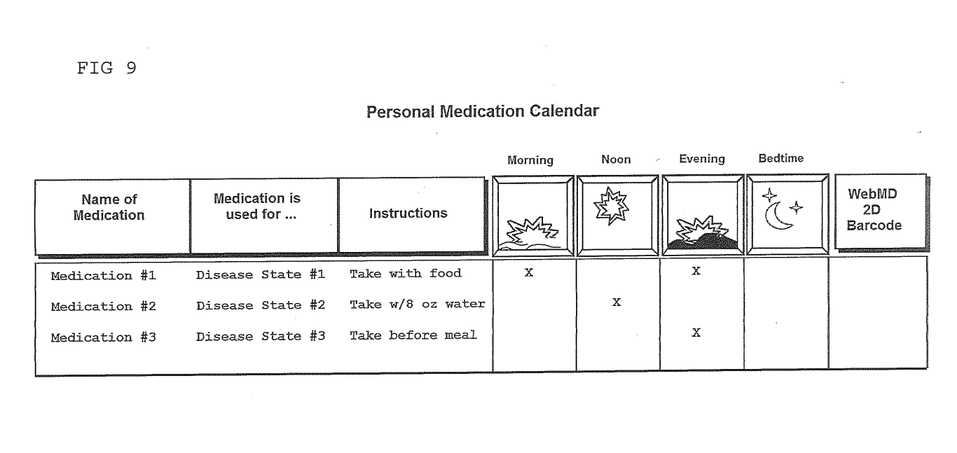

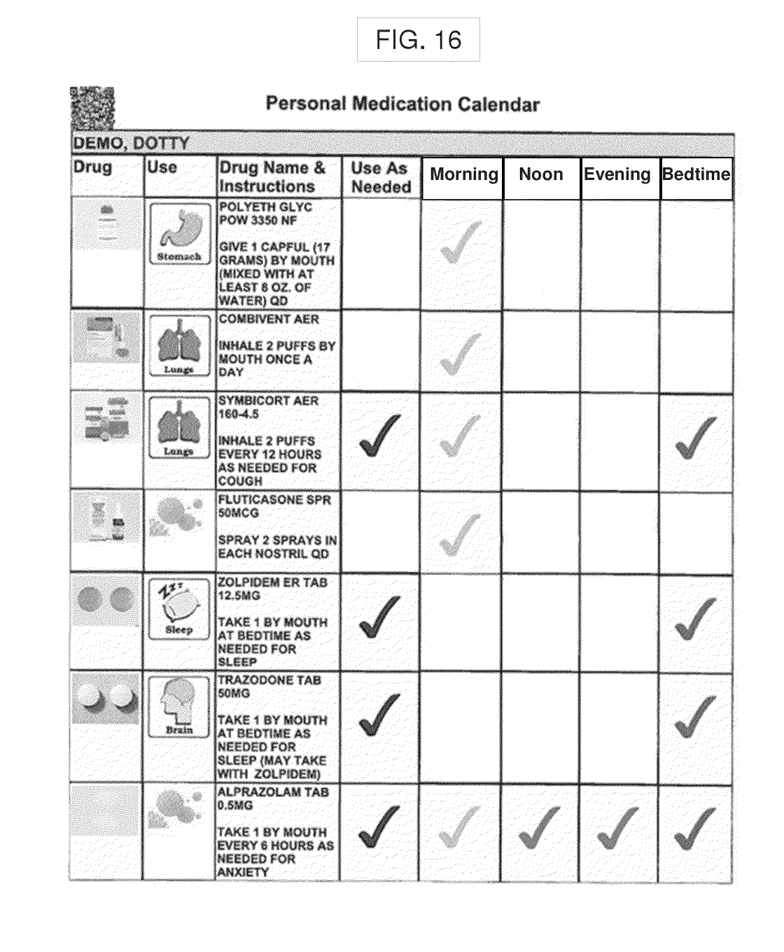

The prescription preparation function may be responsible for filling and packaging the patient's newly synchronized prescription plan. A single pharmacy may create a customized packaging solution that contains co-mingled (when permitted) medications in one or more medical containers on a patient customized administration schedule. The one or more medical containers may be pouches, blisters, bottles, trays, bags, or any other such containers suitable for holding medication. The prescription preparation function may also include creating a set of instructions for all the medications as well as determining a patient customized drug regimen that determines in which of the one or more medical container(s) the various medications may be packaged. The set of instructions may include one or more of the following a calendar, a table, digital forms, etc. and including information such as drug indication, side effects, patient friendly instructions, drug description, drug strength, medication icons, symptom icons, time of day icons, and/or complete list of all medication whether contained within the customized packaging or not. FIGS. 9 and 16 are sample formats for a calendar. It is to be understood a variety of formats could be used. The prescription delivery function generally comprises delivering the PCDR and customized packaging to a retail pharmacy, patient, assisted living, independent living, hospital discharges, hospital, skilled nursing facility, and home community based health care. A pharmacy technician or health care provider may then contact the patient for delivery or pick-up of the medications or in the case of institutional settings deliver the customized package and PCDR instructions to the patient. The calendar may include icons and/or words to convey information to the patient or caregiver, such as time to take medication, disease state that the medication is for (heart, lungs stomach . . . ) etc. . . . The calendar may use a variety of colors to assist in quick identification of medication and/or dosage regimen information such as the same color used for all morning pills, afternoon pills, evening pills, and/or bedtime pills. This color may also show up on the medication pouch or package created for that time period to further assist with patient adherence. The calendar may include pictures of the medication to assist the user in confirming the package has been filled correctly and/or the patient/caregiver that they are taking/providing the correct medications at the correct time. The calendar may also be barcoded such that additional information may be easily reached by the patient scanning with a smart device and/or so the calendar may be scanned to confirm that it is being provided with the correct patient package.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

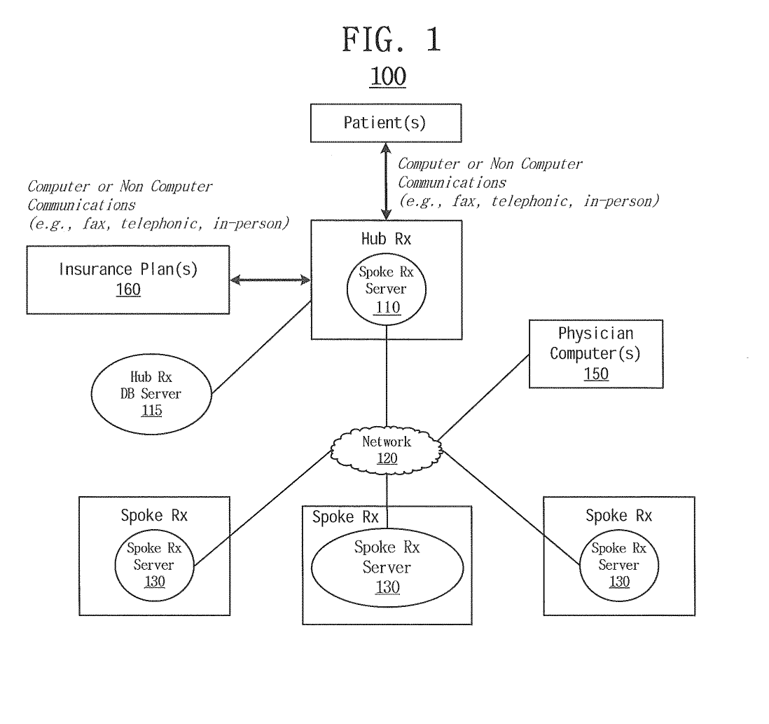

FIG. 1 illustrates a network architecture diagram 100 of an embodiment of an MMAA system to facilitate delivery of multiple medications in an adherence friendly synchronized manner. The MMAA system may be built upon a hub and spoke type of logical architecture in which a centralized hub pharmacy may be associated with multiple spoke pharmacies. The hub pharmacy may act as the central point of activity for the MMAA system. The spoke pharmacies, in turn, may have direct relationships with patients and physicians. Thus, a hub Rx server 110 may be representative of a computer system associated with a hub pharmacy and an MMAA website for coordinating MMAA system activities. The hub Rx server may be coupled with a network 120 such as, for instance, the Internet. In addition, the hub Rx server 110 may also be coupled with a hub Rx database server 115. The hub Rx database server 115 may include multiple databases for storing data pertaining to the MMAA program. Multiple spoke pharmacy Rx servers 130 as well as one or more prescriber servers or computers 150 may be coupled with the network 120 to permit data exchanges with the hub Rx server 110. Network enabled patient computers and/or network enabled physician computers 150 may also be communicable with the spoke Rx servers 130 and/or the hub Rx server 110 over network 120 if so desired. Moreover, the hub pharmacy personnel may communicate with multiple insurance plans 160 and/or multiple physicians. It is to be understood that the Spoke Pharmacies may be linked to contact one or more insurance plan(s) 160.

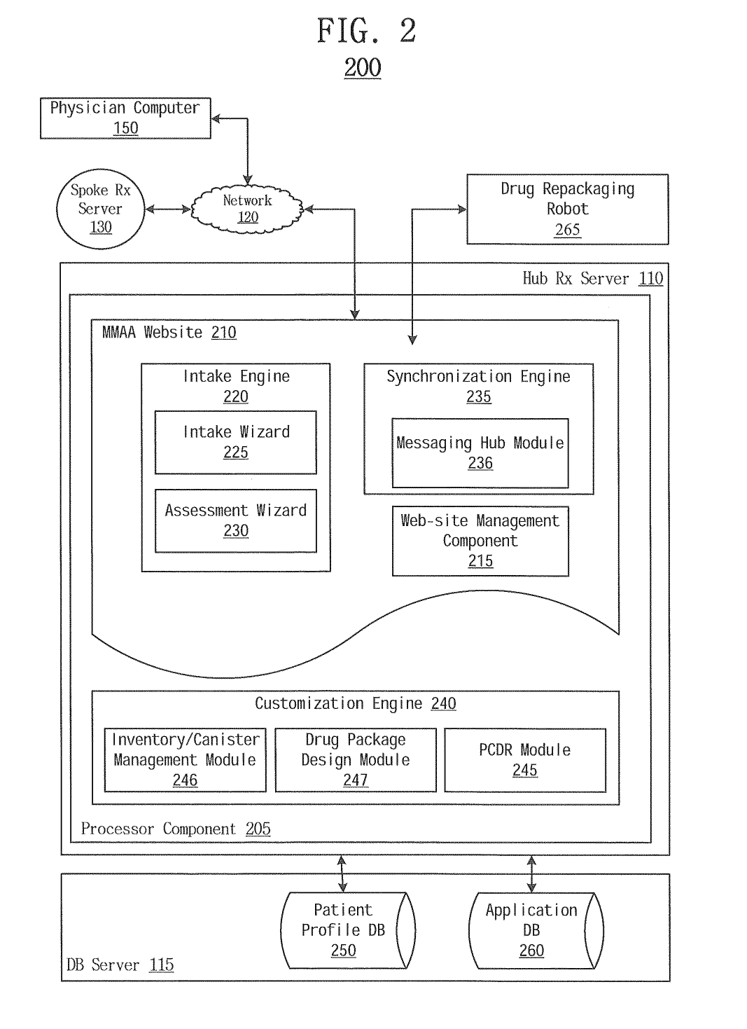

FIG. 2 illustrates a block diagram of an embodiment of an MMAA system 200 to facilitate delivery of multiple medications to patients in an adherence friendly synchronized manner. In one embodiment, the MMAA system 200 may comprise a computer-implemented system having one or more components. Although the MMAA system 200 shown in FIG. 2 has a limited number of elements in a certain topology, it may be appreciated that the system 200 may include more or less elements in alternate topologies as desired for a given implementation.

The MMAA system 200 may include a network device, such as the hub Rx server 110. The hub Rx server 110 may be generally arranged to host and execute one or more additional MMAA system components. For instance, the hub Rx server 110 may host an MMAA website 210. The MMAA website 210 may be stored on the hub Rx server 110 and operable via a processor component 205. The website 210 may be divided into two parts. The MMAA website 210 may include a public part and a protected part. The public part of MMAA website 210 may include general information that does not need to be specially protected via secure access techniques. Typically, the public part of the MMAA website 210 may not allow access to any type of patient information (e.g., healthcare information), account information (e.g., user ID/password pairs), financial information (e.g., credit card numbers), or specific application information that is shared between an end-user (e.g., patient, physician, pharmacy) and the hub Rx server 110. Thus, when an end-user via a web browser seeks access to the public part of MMAA website 210, access may be granted over a connection such as, for instance, the Hypertext Transfer Protocol (HTTP).

HTTP is an application protocol for distributed communication among networked computers. HTTP is the protocol to exchange or transfer hypertext. HTTP functions as a request-response protocol in the client-server computing model. In this case, a web browser, for example, may be the client and an application running on processor component 205 hosting MMAA website 210 may be the hub Rx server 110. The client submits an HTTP request message to the web server 110. The hub Rx server 110, which provides resources such as Extensible Markup Language (XML) files, Hypertext Markup Language (HTML) files and other content, or performs other functions on behalf of the client, returns a response message to the client. The response contains completion status information about the request and may also contain requested content in its message body. Other protocols may be used as well, and the embodiments are not limited in this context.

The protected part of MMAA website 210 may include information and applications that are specific, unique, and private to individual end-users (e.g., physicians, patients, and pharmacies) of the MMAA website 210. Thus, when one of these users accesses the MMAA website 210, it can be done over a secure connection such as, for instance, the Hypertext Transfer Protocol Secure (HTTPS) or other secure communications protocol.

HTTPS is a communications protocol for secure communication over a computer network. HTTPS is widely deployed on the Internet. HTTPS is the result of layering HTTP on top of a secure socket layer (SSL)/transport layer security (TLS) protocol, thus adding the security capabilities of SSL/TLS to standard HTTP communications. HTTPS may provide authentication of the MMAA website 210 and associated web server 100 with which a remote computer is communicating over a network. HTTPS provides bidirectional encryption of communications between a client and web server 100, protecting against eavesdropping and tampering with and/or forging the contents of a communication. In the present example, HTTPS provides a reasonable guarantee that a remote computer is communicating with the intended MMAA website 210 and ensures the contents of communications between the user and MMAA website 210 cannot be read or forged by a third party.

The hub Rx server 110 may be communicable over a network 120 such as, for instance, the Internet. In turn, the network 120 may be communicable with multiple network enabled computers such as spoke Rx servers 130, patient computers 140, and physician computers 150. The connections between the network enabled computers 130, 150 and the web server 110 over network 120 may be achieved using the aforementioned HTTP or HTTPS depending on the part of the MMAA website 210 with which a network enabled computer 130, 150 wishes to communicate.

The protected part of MMAA website 210 may include multiple components. The multiple components may include, for instance, a website management component 215, a patient intake engine 220, a synchronization engine 235, and a customization engine 240.

The website management component 215 may comprise a software application under control of the processor component 205. The website management component 215 may be generally arranged to manage the interfaces between the MMAA website 210 and other external components such as a network 120 (e.g., Internet) and multiple databases. For example, the MMAA website 210 may be communicable with a database server 115. The database server 115 may be communicable with the hub Rx server 110 over a local network connection and may include a patient profile database 250 and an application database 260. Communications with the patient profile database 250 and an application database 260 may be performed by, for instance, a structured query language (SQL) interface. The embodiments are not limited to these examples.

The patient profile database 250 may store without limitation information pertaining to patient medical history, patient prescription data, patient insurance data, physician data, and adherence survey data. The application database 260 may store without limitation information pertaining to user registration such as login data, billing information, and user information such as contact data. The collection, storage, and management of all health related information shall be compliant with the Health Insurance Portability and Accountability Act (HIPAA). The embodiments are not limited to these examples. It is to be understood alternate database arrangements may be done and the patient and application data may be stored in the same database if so desired.

The website management component 215 may be further arranged to manage the MMAA website 210 accounts of end users and access by end users to the MMAA website 210. There may be two types or levels of MMAA website 210 users—end-users and website administrators. MMAA website 210 administrators may control information and services provided to the end-users on the protected and public parts of the MMAA website 210. End-users may use the MMAA website 210 to access various services provided by the MMAA website 210. All communications between the MMAA website 210 and its end-users may be performed over HTTPS.

The website management component 215 may be further arranged to manage the end-user registration process. For example, end-users may register with the MMAA website 210 using an appropriate secure socket layer (SSL) protected website form. Registration may entail creating a private user identifier (ID)/password pair using an SSL-protected website form that corresponds with the end-user. A registered end-user may login to the MMAA website 210 by providing their private user ID/password pair. If a User ID does not exist, a generic error message may be displayed such as, “Wrong login or password”. An end-user's User ID and password may be stored in the application database 260.

The end-user's password may be hashed such that the end-user's hashed password may be compared with one stored in the application database 260. If it is incorrect, the same error message may be displayed. The MMAA website 210 may employ techniques that make it impossible to recover a forgotten password. Rather, a new password may be assigned using a standard access recovery and verification routine. The verification routine may entail having the end-user answer one or more pre-determined personal questions the end-user chose during the registration process. The embodiments are not limited to these examples.

The patient intake engine 220 may comprise a software application under control of the processor component 205. The patient intake engine 220 may be generally arranged to guide and assist an end-user in populating the patient profile database with the end-user's personal and healthcare information relevant to the MMAA program. The patient intake engine 220 may include a patient intake wizard 225 to perform this function. The patient intake wizard 225 may be a software module that prompts the end-user for responses to queries. The patient intake wizard 225 may ask the patient to answer questions pertaining to eligibility in the MMAA program. As an example, a patient may be eligible for the MMAA program only if they approve non-child resistant packaging, are not subject to mandatory mail order for prescriptions, and have a minimum number of qualifying medications, two (2) or more qualifying medications that are currently being prescribed. Those eligibility requirements are by example only, other factors may be used to determine eligibility for the program. Utilizing the patient intake wizard 225, patient data, chart history, prescription data and insurance information may be entered into the patient's profile and stored in the patient profile database 250.

The patient intake wizard 225 software may be designed as a web-based program that each spoke pharmacy location may log into from their own spoke Rx server 130. Collected patient intake data may be used to create a patient profile in which all of a patient's prescriptions may be linked to one file. Prescription data collected by patient intake wizard 225 may be forwarded to the synchronization engine 235 to be synchronized. The term “synchronization” may be used to define a process in which the hub Rx server 110 (e.g., a hub pharmacy technician) contacts the patient's insurance plan 160 to request the insurance plan 160 authorize all existing prescriptions in the patient's file based on an objectively determined adherence assessment and approve a synchronized prescription set for subsequent adjudication by a spoke pharmacy. In the alternative, it is to be understood that the hub and/or spoke pharmacy may obtain all new scripts of the patient's medications no adjudication is needed.

As part of the patient intake wizard 225, an adherence assessment module 230 may be implemented to classify a patient's present adherence level pertaining to their ability to take all of their prescribed medications on the recommended administration schedule and/or to identify a patient's adherence risk. The adherence assessment module 230 may determine a score based on a number of factors used to determine the patient's need for an adherence-based packaging solution. The adherence score may be used as the basis to request an insurance plan 160 to clear all previous prescriptions in a patient's file and allow for a synchronization of new prescriptions pursuant to the MMAA program. A patient's adherence need may be determined from the answers to the questions using a variety of determined acceptable adherence standards. The adherence standards may change based on the risk comfort level or needs of the patient, provider, pharmacy benefit manager and/or insurance plan. Answers to certain questions may automatically indicate the patient is a good candidate without any scoring tool being used. In addition, the patient's life-style or activities of daily living may qualify them as an adherence program candidate.

The adherence assessment module 230 as administered by the patient intake wizard 225 may ask the patient to answer a series of questions. The questions may include, but are not limited to, the number of pharmacies the patient is currently utilizing, the number of physicians they have that are currently prescribing medications, the number of medications, admission into a skilled nursing facility, the number of hospital and/or emergency room (ER) visits within the last 30 days, how many medications the patient is taking, the patient's health condition/disease state, and whether the patient feels they would benefit from an adherence intervention or a support service such as reminder packaging. These questions are by no means all inclusive, and alternate questions may be used or added to determine whether a patient would benefit from an adherence program.

With respect to the first question, a score of 0 points may be assigned if the patient utilizes a single pharmacy. However, a score of 2.5 points may be assigned if the patient uses two pharmacies and a score of 5 points may be assigned if the patient uses three (3) or more pharmacies. With respect to the second question, a score of 0 points may be assigned if the patient sees a single physician. A score of 2.5 points may be assigned for two physicians and a score of 5 points may be assigned if the patient sees three (3) or more physicians. With respect to the third question, a score of 0 points may be assigned if the patient has not visited a hospital/ER in the last thirty (30) days. A score of 1 point may be assigned for one hospital/ER visit. A score of 5 points may be assigned for two hospital/ER visits and three (3) or more hospital/ER visits may have a score of 7.5 points assigned. With respect to the fourth question, if the answer is yes, a score of 5 points may be assigned. If no, 0 points are assigned. The adherence assessment module 230 may then calculate a total score for the patient based on the answers provided. A total score of less than 10 points may indicate the patient has only a moderate adherence issue. A score of greater than 10 points, however, may indicate the patient has a severe adherence issue. The embodiments are not limited to these examples. Different score values may be assigned based on answers and different questions may be used to solicit the answers. The greater the number of high risk responses the greater the need for adherence assistance. In some situations, a single high risk response may be sufficient to support a need for adherence intervention.

The patient intake engine 220 may automatically provide the patient's prescription and insurance plan information to a hub pharmacy technician via a user interface and schedule a time for the hub pharmacy technician or health care provider to contact the patient's insurance plan 160 to request the insurance plan 160 authorize all existing prescriptions in the patient's file based on the assessed adherence need.

The hub pharmacy technician may receive the data from the patient intake engine 220 and call the insurance plan 160. The hub pharmacy technician may request the synchronization of the patient's prescriptions. If the insurance plan 160 approves the request, a spoke pharmacy technician may then successfully adjudicate the prescriptions. If the insurance plan 160 does not approve the request, the prescription(s) may be removed from the first 30-day supply (or whatever period of days are chosen for the first customized package) and may be added to the following cycle. The spoke pharmacy technician may obtain a reduced quantity prescription in order to provide the patient with a “reduced fill” prescription in a vial for the medication(s) that were not synchronized on the appropriate date.

The synchronization engine 235 may provide a scheduled time period for a spoke pharmacy technician to adjudicate the patient's prescriptions. Adjudication may be necessary to ensure coordination with the synchronization step in which the insurance plan 160 has approved and replaced the patient's existing prescriptions with “synchronized” new prescriptions. The insurance provider of health plan may need to approve of the date for the script to be filled. A set production schedule may coordinate these time periods between the hub pharmacy contacting the insurance plan 160 and a spoke pharmacy adjudicating the prescriptions. It is to be understood, based on system preferences, that the spoke pharmacy may contact the insurance plan and that no adjudication may be necessary or that the hub pharmacy may perform adjudication for the spoke pharmacy.

The synchronization engine 235 may also calculate a synchronization date based on a hub pharmacy production schedule. Following the adjudication process, the spoke pharmacy may send the patient's prescriptions to the hub pharmacy in an electronic format consistent with that used for typical central fill facilities. These prescriptions may be flagged to designate fulfillment to be completed at the hub, mail order, spoke or central fill pharmacy.

The customization engine 240 may automatically receive the patient's prescription orders from a spoke pharmacy. The prescriptions may be downloaded from a secure file transfer protocol site (sftp), virtual private network, or pharmacy interface on a pre-determined interval. The prescription orders may contain the physician's instructions for taking the medication and/or a product identification code. The product identification code in this situation may be the national drug code (NDC), the generic product identifier (GPI), and/or the generic code number (GCN). The physician instructions are assigned to the particular medications for each prescription. The customization engine 240 may also obtain prescription data from external sources (e.g., First Data Bank, Medi-Span, American Geriatric Guidelines, OBRA Guidelines), by using the product identification code, as well as a proprietary file for each specific prescription. It is to be understood that the customization engine may also search internal databases for this information. The product identification code that it uses to search may be the NDC code, the generic product identifier (GPI), and/or the generic code number (GCN). This second set of dosing instructions for each script is also assigned to the respective medication(s).

The prescription orders and the prescription data may be used to determine a combined dosing regimen that has the instructions for taking the individual medications. Where there is a conflict between the two sets of dosing instructions, the customization engine may alert the user, such that the user may contact the physician and confirm the proper dosing instructions. In the alternative, the customization engine may automatically contact the prescribing physician via email, text, fax, automated call, IM etc. . . . and alert him/her to the conflicting prescribing data and solicit his/her correction in that manner. Where there are no prescribing instructions, the dosing instructions are set to a default setting. This default setting may be morning, night, afternoon, or any other chosen period suitable for the patient's schedule or system preferences.

The dosing schedule is combined with personalized patient information to create a Patient Customized Drug Regimen (PCDR) schedule that determines which medications, based on the patient activities of daily living, need to go in which medical container(s) of the customized medication package. Only qualifying medications or medications that can be packaged into the medical containers by the robotic packaging machine 265 will be placed into the customized medication package. Extended packaged or reminder instructions may be placed on the outside of the package to remind the patient to take any non-qualifying medication. Qualifying medications are medications that the robotic machine is instructed and capable of packaging into the customized medication package, whether it be by using a drop try or by standard operation of the robotic machine. Non-qualifying medications may include inhalers, liquid medication, patches, topicals, sublinguals, troches, powders, atomizers, infusions, injections, sprays, drops, effervescents, capsules, suppositories, or medications that should not be combined or will not work with the robotic machine.

Personalized patient information may be their specific symptoms to the drugs, schedules (personal or professional or medical), and/or conflicts between medications.

### PCDR Assignment Process

The customization engine 240 may also be configured to execute a medication dosing assignment module or PCDR module 245 that determines how various medications may be placed into individual medication containers. A prescription order data set that includes multiple prescriptions for various medications may arrive from a spoke pharmacy for filling. The dosing assignment module 245 may parse the prescription data for each prescription to determine any specific physician assigned dosing instructions in the SIG (prescriber instructions). If the physician/prescriber has assigned specific dosing times in the SIG, then those dosing instructions are incorporated into a PCDR schedule. If not, the remaining prescription data will flow to an MMAA dosing assignment program implemented by the dosing assignment module 245. Each medication's Product Identification Code (PIC) may be used to match codes indicated in a proprietary file developed from one or more internal database(s) and/or an external source such as the aforementioned First Data Bank, Medi-Span, Drug Manufacture Guidelines, Red Book, Gold Standard, American Geriatric Guidelines, OBRA Guidelines and/or any other similar sources. If a match for the PIC is found for a given prescription, that dosing instruction may be utilized for that prescription. If not, all remaining prescriptions may be provided a default dosing assignment.

The dosing assignment module 245 may then determine whether a medication from a prescription can be co-mingled and identify these medications as requiring a separate medication container according to that medication's GPI. The non co-mingled medications may then be packaged in separate medication containers with the first default assignment and labeled as “1 of total (e.g., “1 of 3”, “2 of 3”, and “3 of 3”) for a dosing period. In the alternative, a medication in the robot machine inventory may be identified as being co-mingled or not co-mingled. Co-mingling may be an assignment done at the robotic packaging machine.

Color coding may be used on the multi-med application label(s) to indicate time of day to take drugs contained in the multi-med package. Additionally other symbols could be used to indicate the time of day to take the medication in the package. Furthermore, vials, blister packs and other such medication containers that may or may not be a part of a multi-med package could use color coding, icons, symbols or particular wording to indicate the time of day to take the drugs, the particular patient in a multi-person household, the type of drug contained in the package, and/or the strength of the drugs.

The first default assignment may be labeled the “Morning/AM” period, based on an assumption that patients will likely take their medications before starting their daily activities. The customization engine 240 may determine the number of medications that have been assigned to the “Morning/AM” pouch. The dosing assignment process may cap the number of medications for any given administration time at any number chosen by the program users. For example, up to four pills per administration time, up to two pills per administration time, up to 6 pills per administration time, or other such chosen number. This number may be assigned based on patient preference, patient abilities to swallow medication, patient age, doctors/prescribers preference, filling pharmacies preference, medication container size, medication available strength, SIG, care giver preference, pharmacist preference, federal rules and regulations and/or other such reason.

If the “Morning/AM” pouch has not been filled by the pre-determined number of medications, the next prescription in the file may be assigned to this medication container. The next prescription in the file may then be assigned to the current medication container until that medication container reaches its maximum limit of four medications or whatever the chosen maximum number is. If there are additional medications to be assigned, the customization engine 240 may repeat the same process for a second dosing period, such as an afternoon container, mid-morning container, evening container etc. . . . There may be multiple dosing periods throughout the day. For some patients two dosing periods are sufficient, for others up to four, for others up to 8, and so on. The system may have a set number of dosing periods arranged in a prioritized filling order such as—morning dosing period always filled to maximum first, followed by evening dosing period, followed by afternoon dosing period, and so on, or the system may allow for customization of dosing period prioritization based on patient, prescriber, pharmacist, activities of daily living, insurance provider, care giver or another such persons or reasons preference. If there are still additional medications to be assigned, then the customization engine 240 may repeat the same process for a third dosing period. The dosing assignment process repeats until all prescriptions in the file have been assigned to a specific dosing period.

The PCDR module 245 may be programmed to assume that all prescriptions taken less frequently than daily will have a calendar date for administration listed in the SIG. The PCDR module 245 may further be programmed to assume that all medications to be taken at multiple administration times within a 24 hour period start with the “Morning/AM” assignment. The customization engine 240 may also be programmed to assume that prescriptions with alternating medication strengths will have the calendar date of administration of the first dose in the SIG. Any deviation from these assumptions or a lack of data for these cases may be rejected back to the spoke pharmacy to contact the prescribing physician for clarification or to generate an automated communication to the prescribing physician's office for clarification. A hub pharmacy technician may access the customization engine 240 via MMAA website 210 to review any pertinent physician notes and match the patient's prescriptions to the medications currently available in the canisters contained within the drug packaging robot 265. The customization engine prepares one or more set(s) of instructions for the customized medication package. This set of instructions may be a digital set of instructions that can be programmed into a phone or device or emailed to a patient and/or pharmacist and/or doctor or it may be a one-page HOA patient label, an adherence calendar, packaging instructions, packaging labels, inventory reports, and/or delivery reports. The set of instructions may contain the patient's PCDR, drug information, pill count, pharmacy information, prescriber information or other such information.

The customization engine 240 may have a quality assurance technician review and check all reports before forwarding an order to a robot filler 265. The customization engine 240 may then prepare the customized packaging and print out or send one or more set of instructions, which may be a patient label, adherence calendar, or any other set of instructions that complement the patient's customized packaging. The customized package may contain individually labeled pouches, wherein the labels may be icons or instructions to indicate dosing time for the medications contained within the pouch, or other types of dosing instructions.

The drug package design module 247 may assign the appropriate dosing instructions to the individual medication containers within the customized package as well as one or more of other patient specific and/or container specific information, including but not limited to patient name, day of the week, date to be taken, time to be taken, drug name(s), drug code, drug strength, number of tablets of each drug in the individual container, Rx number, product identifier code, expiration date of the product, manufacturer, manufacturer lot number, name address and/or phone number of the pharmacy packaging and/or dispensing, medication indication (indication for which the medication is prescribed), prescriber's name, description of the medication and/or imprint, package certification number, and/or the number of containers to be taken per dosing period. Based on manufacturing preferences, the dosing instructions and or other specific patient information may be contained within the set of instructions created separately and/or printed directly on the customized package itself. It is to be understood that icons may be used instead of wording. Once completed, the hub pharmacy technician may place the customized packaging and documentation into a hub checking stage.

### Hub Filling Process

A customization engine 240 identifies the available canisters in inventory through its inventory canister management module 246 and may print or display a Special Tablet System (STS) report from the customization engine 240 for a store level batch. If desired, the customization engine may delay running a patient's customized package if there is a medication requiring the special tablet system. Medications that may require the special tablet system may be one or more of the following: half tablets, cyto-toxic medications, medications without an available canister, medications that are friable or have heat sensitive coatings, or any medication that requires special handling. Any medications that are not available in the robot canisters may be filled utilizing the STS process. When the STS report is being run, the inventory canister management module 246 is also checking the drug inventory within the robot filler 265.

The inventory canister module 246 may track inventory coming into the pharmacy from multiple places, assign origin information to the inventory and customize the canister(s) in the robotic filler to receive the inventory under one or more of the following identification codes, including but not limited to: customers name, patient's name, drug name, providers name, prescribers name, insurance providers name, drug number, drug PIC, etc. . . . The identification code may be used to assist the robot filler in determining which of the canisters to use when filling an order. The customization engine 240 will facilitate filling and refilling of the canister through the use of identification codes, which may be associated with a barcode. The manufacturers medication may be associated with particular information including but not limited to drug name, image, strength, expiration date, lot number, pill size, drug location, drug linkage, pharmacy information, provider information, technician handling etc. . . . All this information may be stored within the inventory management module 246 to assist the hub pharmacy in tracking the medication used to fulfill scripts.

The inventory canister module 246 may also track and alert the user regarding canisters that are not being utilized. This may prevent the drugs from expiring, may promote better storage for the medications, allows for more efficient usage of the robotic machine such that the canister may be re-purposed for a medication that is used more frequently. The inventory consider module 246, compares incoming orders against the available canisters and may sort the processing batches so they may be run most efficiently. For example, the module 246 may identify which orders will need drugs not currently in available canisters, and pushes those runs towards the end so the user may reduce the number of times the robotic machine canisters need to be changed. All orders, whose medications are currently within the machine, will be processed in a row or a continuous batch if so desired. Once the first set is done, the user will be able to review the an inventory report from the inventory module 246 and switch or add all the canisters needed to run the second batch or the batch of orders moved to the end of the run.

The customization engine 240 may print or display an inventory report after it determines which canisters need to be re-filled prior to any batch runs. If the medications are available, the hub robot technician may refill the canisters, leaving the filled canisters in the staging area. If the medications are not available or in a “back-order” status, the hub robot technician may switch manufacturers for the product in the system, deactivate the existing canister in the robot, and then add the prescription to the STS report. Patients having a dispense as written (DAW) prescription that is not available due to a short supply, may have that prescription filled directly at a spoke pharmacy.

The hub pharmacist may check all of the re-filled canisters in the staging area prior to placing the canisters back into the robot. The hub robot technician and the hub pharmacist may then sign an electronic canister fill log in a customization engine 240 inventory management module 246. The hub robot technician may then ensure that the robot filler has an adequate supply of pouches and print ribbon for a batch run. The hub robot technician may review the final STS Report, scans their unique ID (bar code) and the STS report, thereby initiating a record which the customization engine 240 may write to the patient profile database 250. The patient profile database 250 keeps a record of how their medication package was prepared, including but not limited to the technician who packaged it, the technician who checked the tray, the technician who quality checks the package, the technician that packaged it for shipping, the date run, the time scanned, the manifest is checked against the staffing log, the medications in the package, the set(s) of instructions, the instructions printed on the medication containers, the instructions sent with the medication package, the specific patient's information, the dispensing pharmacy information, the filling pharmacy information, the tray number and slot number for the STS system. It is to be understood that the foregoing could be performed by a pharmacist or a technician.

The hub robot technician may locate and brings all medications required by the STS report to the STS filling area. The trays may then be filled in the order they will be staged for the batch. The hub robot technician may leave the medication containers in the area for inspection and sign the electronic STS report. The hub pharmacist may scan their unique ID (bar code) and checks 100% of the STS trays against the original medication containers for the batch. The hub pharmacist may then electronically sign the STS report, thereby completing the record in the customization engine 240 program. The hub robot technician may return all medications required by the STS report to their original location.

The hub robot technician may then initiate the batch for the robot filler. When the robot requests an STS tray, the hub robot technician may scan their ID and the STS tray prior to staging within the robot. The hub robot technician may monitor the filling process for the batch, repeating the STS tray staging as requested by the robot. If a canister issue develops, the robot display may identify the type of problem and the location of the canister. The hub robot technician may address any issue that is required and re-start the filling process for the robot. During the batch, the hub robot technician may be monitoring the packaged medications as they exit the robot for any obvious process or medication defects. If a problem arises, the hub pharmacy technician may pause the robot filler and diagnose the problem, and may restart the robot as necessary to complete the batch.

### Quality Assurance Checks

The hub quality assurance (QA) technician may retrieve each medication strip pack from the robot and place it in a QA inspection area. The hub quality assurance technician may scan their ID as well as the individual strip pack they are checking to create a record in the customization engine 240 program in the name of the QA technician conducting the check. The hub quality assurance technician may visually check each pouch for crushed or broken tablets, miss-drops, print quality issues, defective pouches, and the required number of tablets per HOA. Any defective pouches may be de-blistered and the patient order may be repackaged to correct the defect (repeat filling process). Once the batch check is completed, the hub quality assurance technician may scan their ID and electronically sign the manifest, and then stage the pouches for the hub pharmacist to review. If there is an error or an issue with a package, the customization engine may create a label for that specific package that contains the printed information that was on the original package or adjusted information for the corrected package. The technician can then place the label onto the corrected package. In the alternative, an error message may be placed on the package with corrected instructions—don't take the extra pill. The re-print or adjusted instructions may be inputted by a pharmacist, prescriber, robot machine operator, technician and or any other qualified person.

The customization engine may use a drug package modification system to allow the pharmacist to access a batch that has been run, make a manual correction within the package run, print reports to show correction and/or labels to show correction, and review any packaging errors and corrections. The user may identify the batch by using one or more of the following: including but not limited to, patient name, batch number, bar code, patient code, drug name, prescriber name, spoke pharmacy identifier, technician etc. . . . The corrected information is added to the patient's customized package report and the new order merged with the existing order. Instructions and/or labels may print automatically or may display automatically. The pharmacist will then be able to make and easy manual correcting within the container and reseal the package. This system allows for package correction without needing to run the entire script again, which decreases time and waste. In addition, should a recall issue, this process allows for manual correction with reduced packaging errors as the recalled drug may be pulled and the remaining drug left unaffected in the packages.

The hub pharmacist may scan their ID and the individual strips of pouches to create a record in the customization engine 240 program of the name of the hub pharmacist conducting the check. The hub pharmacist may visually check the header pouch of the strip against a manifest, the actual ID of the medications against the prescription, and ensure the HOA matches the physician's directions. Once a batch has been checked, the hub pharmacist may scan their ID and electronically sign the manifest. The hub quality assurance technician or robotic machine may roll or stack the individual medical containers or pouches and prepare them for placement into dispenser cartons or customized medication package. The customized medication package may then be placed in a staging area for shipping preparation.

In the alternative, software and/or mechanical means may be used alone or in combination with human technicians and or pharmacists to do optical character recognition, OCR, testing to confirm the medications contained in the packaging is correct. A customized medication package preview report may be prepared for each patient's customized medication package. The preview report may be used to compare against the final packaging to confirm the packages are filled correctly. The PCDR report may also be used alone or in combination with the preview report to confirm the customized medication package is prepared correctly. In addition to OCR, high speed videos and/or cameras may capture images of the packaging and be used to compare against the preview report and/or the PCDR report and/or the drug image files.

### Packages Prepared for Shipment

The hub quality assurance technician may scan the rolled pouches for the store level batch. The hub quality assurance technician may then match the patient's calendar to the corresponding package with attached patient label patient receipt, and patient information leaflets and the manifest, bar code scan each item, and then place the strip pouches into the labeled package. The customized packaging may then be closed and the patient calendar, patient receipt, and patient information leaflets are packed and bagged, affixed or inserted into the carton. Each completed patient order may then be staged in the batch order area. The hub quality assurance technician may scan each filled patient order prior to placement in a shipping tote. The hub pharmacist may rescan each individual patient as they are placed into the individual spoke pharmacy shipping tote. The scans may be checked against the spoke pharmacy manifest as a final quality check. The hub quality assurance technician may then secure the spoke store shipping container and pack the shipping manifest in the container. A copy of the shipping manifest may be retained at the hub pharmacy. The shipping tote and associated shipping documents may be given to a delivery service provider to ship the customized packaging to the spoke pharmacy location.

### Medications Shipped and Dispensed to the Patient

The spoke pharmacy technician may receive the shipping tote and scan in all medications from the master shipping manifest. The spoke pharmacist may enter their signature of receipt into the spoke pharmacy system. This scan may release the prescription for customer pick up from the spoke pharmacy's system and send an electronic receipt back to the hub pharmacy. The spoke pharmacy technician may place finished packages in a designated “will call” storage area. A spoke pharmacy AVR (automated voice response) may call the patient to inform them that their medications are available for pick up. Alternatively, the spoke pharmacy and patient may arrange for delivery of the customized prescription packaging. The patient may arrive at the pharmacy to pick up their customized package of medications and the spoke pharmacist may discuss the medications, show the patient how their medications are packaged, how to open the containers, and discuss the information available via the associated bar code or other databases, websites, sources. The spoke pharmacist may also perform an MTM/CMR, including explaining and discussing the importance of medication adherence and how it is supported and enabled by the MMAA customized packaging. At the time the medications are dispensed, the spoke pharmacist may collect payment of the monthly MMAA fee and co-pays from the patient. Payment may also be made before the customized medication package is prepared.

### Refills and Chances to the Medication Routine

The spoke pharmacy, central fill facility or call center may confirm the patient's next multiple prescription order via automated phone call or an on-line reminder tool. The spoke pharmacy AVR may ask the patient if they have any new prescriptions or changes to the existing medications and if so the call may be routed to the spoke pharmacy, the healthcare provider, the hub pharmacy as needed to discuss the changes in prescriptions. The spoke pharmacist may review any new prescriptions or changes and may consult with the prescribing physician as necessary to determine when to initiate the new routine (synchronizing the new or changed prescription). Any changes may be sent to the hub pharmacy for the next fill cycle.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

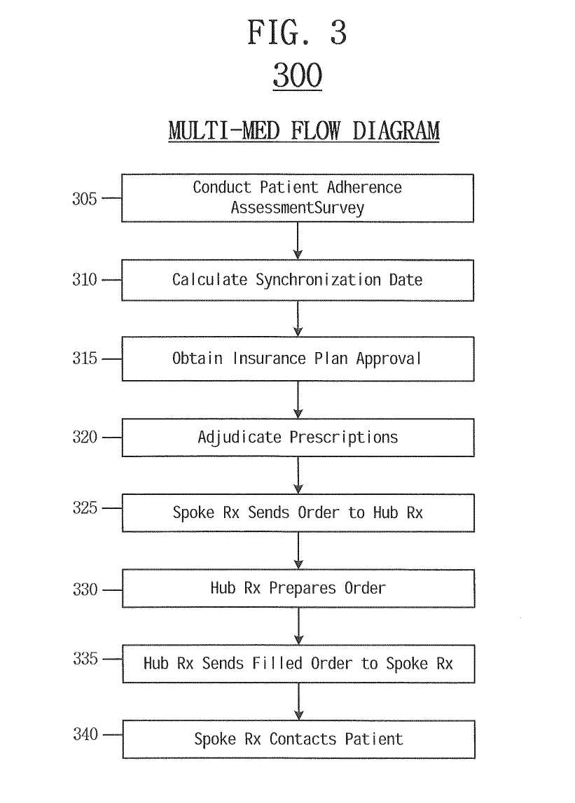

FIG. 3 illustrates an embodiment of a logic flow 300 to deliver multiple medications in a synchronized manner. The logic flow 300 may be representative of some or all of the operations executed by one or more embodiments described herein.

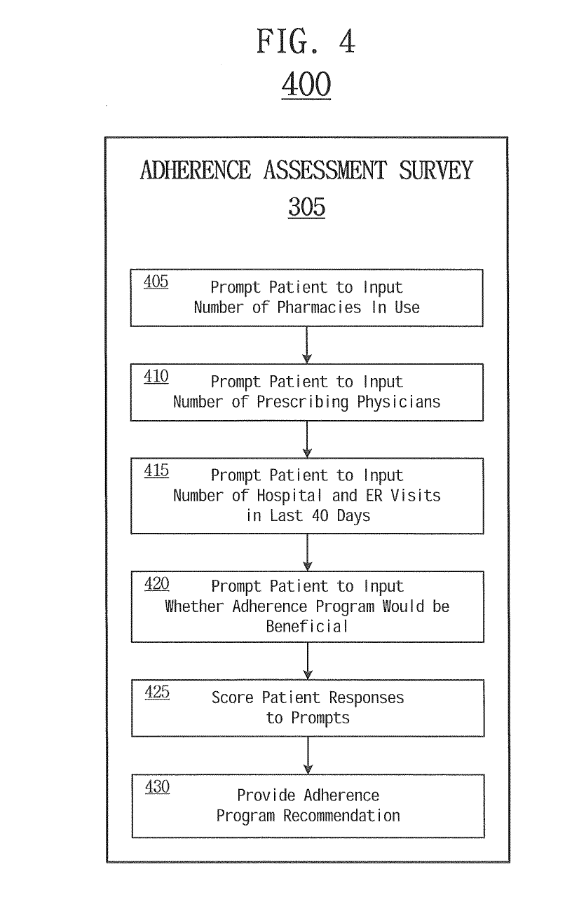

In the illustrated embodiment shown in FIG. 3, the logic flow 300 may conduct a patient adherence survey at block 305. For example, an adherence assessment module 230 may be implemented to classify a patient's present adherence level pertaining to their ability to take all of their prescribed medications on the recommended administration schedule. The adherence assessment module 226 may determine a score based on a number of factors used to determine the patient's need for an adherence-based packaging solution. The administration of the patient adherence survey may be more fully described below with reference to FIG. 4. The embodiments are not limited to this example.

In the illustrated embodiment shown in FIG. 3, the logic flow 300 may calculate a prescription synchronization date at block 310. For example, collected patient intake data may be used to create a patient profile in which all of a patient's prescriptions may be linked to one file. Prescription data collected by patient intake wizard 225 may be forwarded to the synchronization engine 235 to be synchronized into a cohesive schedule for the determined period of days. The synchronization date may be based on the hub pharmacy's production schedule. The embodiments are not limited to this example.

In the illustrated embodiment shown in FIG. 3, the logic flow 300 may obtain insurance plan approval at block 315. For example, a hub pharmacy technician may contact the patient's insurance plan(s) 160 to request authorization of all existing prescriptions in a patient's file to be approved on a modified synchronized determined period of day(s) prescription schedule. The request for approval may be based on a determined adherence assessment need. The embodiments are not limited to this example.

In the illustrated embodiment shown in FIG. 3, the logic flow 300 may adjudicate prescriptions at block 320. For example, adjudication may be necessary to ensure coordination with the synchronization step in which the insurance plan 160 has approved and replaced the patient's existing prescriptions with “synchronized” new prescriptions. A set production schedule may coordinate these time periods between the hub pharmacy contacting an insurance plan 160 and a spoke pharmacy adjudicating the prescriptions. The embodiments are not limited to this example. Adjudication may be done at the spoke pharmacy or dispensing pharmacy. In the alternative, the hub pharmacy may adjudicate or an alternate location may adjudicate. It is to be understood that adjudication may not be necessary.

In the illustrated embodiment shown in FIG. 3, the logic flow 300 may send an order to a hub pharmacy at block 325. For example, once a spoke pharmacy technician has adjudicated a new prescription schedule for a patient, an order setting out the medications associated with revised prescriptions may be sent to a hub pharmacy to be filled. The embodiments are not limited to this example.

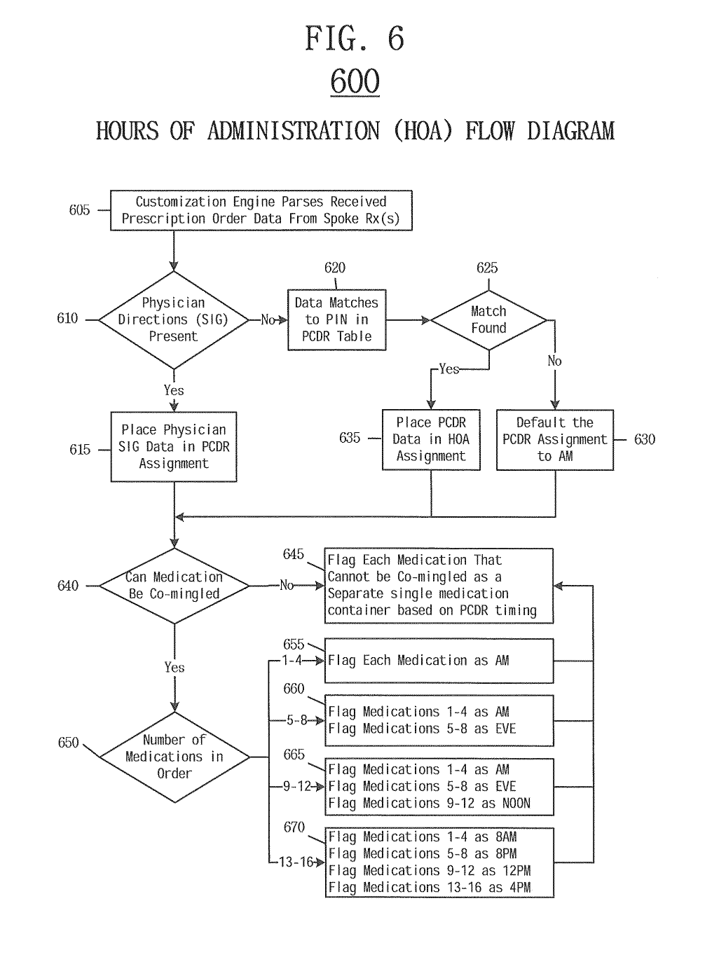

In the illustrated embodiment shown in FIG. 3, the logic flow 300 may prepare an order at block 330. For example, the hub pharmacy may prepare a patient's synchronized order by first determining an hours of administration (HOA) schedule for the blended prescription order. The PCDR schedule may be more fully described with reference to FIG. 6. Once the PCDR schedule assignment process has completed, the hub pharmacy may utilize an automated robot filler process to collect and package the various medications into a customized packaging solution. The robot filler process may be monitored by hub pharmacy technicians for quality assurance (QA) purposes. The embodiments are not limited to this example.

In the illustrated embodiment shown in FIG. 3, the logic flow 300 may ship an order at block 335. For example, a filled and packaged order created at the hub pharmacy may be shipped to an appropriate spoke pharmacy. The spoke pharmacy, in turn, may contact the patient at block 340 to arrange for pick-up or delivery of the customized medication package. The embodiments are not limited to this example.

FIG. 4 illustrates an embodiment of a logic flow to perform an adherence assessment survey. Logic flow 400 may be representative of the steps taken in block 305 of FIG. 3. For example, the adherence assessment module 230 as administered by the patient intake wizard 225 may ask the patient to answer a series of questions. The questions may include, but are not limited to, the number of pharmacies the patient is currently utilizing, the number of medications a patient is taking, the number of physicians they have that are currently prescribing medications, the number of hospital and/or emergency room (ER) visits within the last 30 days, and whether the patient feels if they would benefit from an adherence intervention or a support service such as reminder packaging. The logic flow 400 may be representative of some or all of the operations executed by one or more embodiments described herein. The patient may be prompted to put in the answers or the pharmacist or technician may input the patient answers into the database.

In the illustrated embodiment shown in FIG. 4, the logic flow 400 may prompt a patient to input the number of pharmacies they are currently using at block 405. For example, the patient intake wizard 225 may prompt a prospective MMAA participant to input the number of pharmacies they are currently using. The response choices may include one, two, or three or more. Each response may be associated with a score. For instance, a single pharmacy may be scored at 0 points while two pharmacies may be scored at 2.5 points and three or more pharmacies may be scored at 5 points. The embodiments are not limited to this example.

In the illustrated embodiment shown in FIG. 4, the logic flow 400 may prompt a patient to input the number of physicians that currently prescribe medications at block 410. For example, the patient intake wizard 225 may prompt a prospective MMAA participant to input the number of physicians they are currently seeing. The response choices may include one, two, or three or more. Each response may be associated with a score. For instance, a single physician may be scored at 0 points while two physicians may be scored at 2.5 points and three or more physicians may be scored at 5 points. The embodiments are not limited to this example. In the alternative, the survey could highlight the responses that meet high risk scenarios and send these responses to the physician or pharmacist for adherence evaluation or have a default position if you have 3 or more physicians your risk level warrants participation in the program. The risk comfort level may be determined based on input from the patient, the insurance plans, the physician etc.

In the illustrated embodiment shown in FIG. 4, the logic flow 400 may prompt a patient to input the number of hospital and/or emergency room (ER) visits they have made in the last month at block 415. For example, the patient intake wizard 225 may prompt a prospective MMAA participant to input the number of hospital or emergency room visits they have made in the last thirty (30) days. The response choices may include zero, one, two, or three or more. Each response may be associated with a score. For instance, no visits may be scored at 0 points, a single visit may be scored at 1 point while two visits may be scored at 5 points and three or more visits may be scored at 7.5 points. The embodiments are not limited to this example.

In the illustrated embodiment shown in FIG. 4, the logic flow 400 may prompt a patient to input a response to whether an adherence program would be beneficial at block 420. For example, a prospective participant may be given the option of deciding whether an adherence program would benefit them. If they select “yes”, a score of 5 points may be added. If they select “no”, o points may be added to the score. The embodiments are not limited to this example.

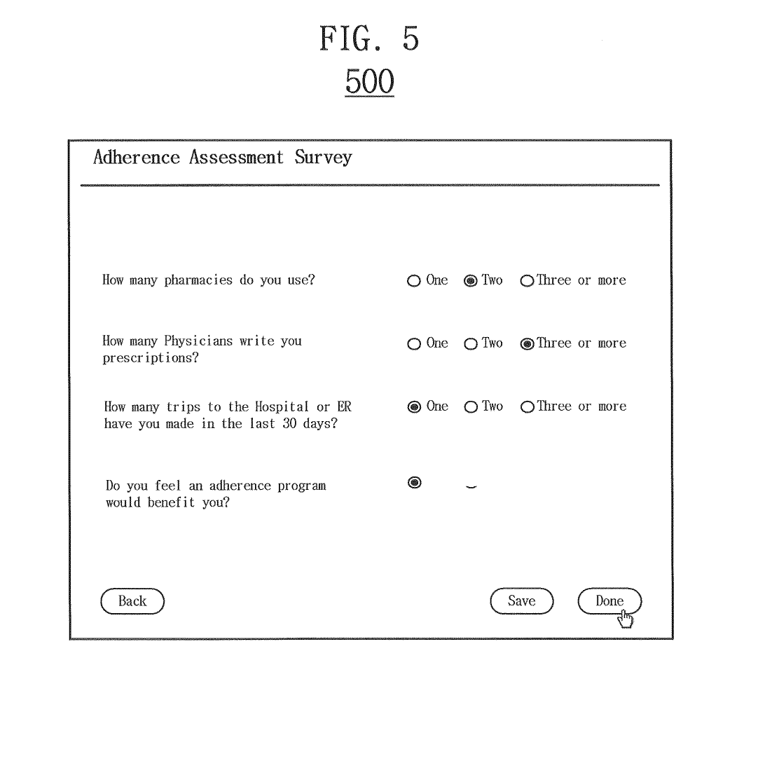

In the illustrated embodiment shown in FIG. 4, the logic flow 400 may score the patient's responses to the survey questions at block 425. For example, FIG. 5 illustrates an embodiment of a computer screen image 500 for an adherence assessment survey. In this example, a prospective MMAA participant has answered the survey questions described above. The responses shown indicate that this person uses two pharmacies (2.5 points), sees three or more physicians (5 points), and has made one hospital/ER visit in the last thirty days (1 point). Lastly, the prospective MMAA participant has indicated that an adherence program would be beneficial to them (5 points). The sum of the individual scores yields a total score of 13.5 points. The embodiments are not limited to this example.

In the illustrated embodiment shown in 600, the logic flow 400 may provide an adherence assessment program recommendation at block 430. For example, the survey may be designed such that a score of less than 10 points may indicate a moderate adherence issue for the prospective MMAA participant. A score of 10 or more points, however, may indicate a severe adherence issue for the prospective MMAA participant. Based on the score in this example, the adherence assessment module 230 may return a result indicating the prospective MMAA participant has a severe adherence issue and could benefit from participating in an MMAA program. The embodiments are not limited to this example.

FIG. 5 illustrates a sample adherence assessment survey. It is to be understood various formats could be used and various questions could be used.

FIG. 6 illustrates an embodiment of a logic flow to reconcile the PCDR schedule for multiple medications. The logic flow 600 may be representative of some or all of the operations executed by one or more embodiments described herein.

In the illustrated embodiment shown in FIG. 6, the logic flow 600 may parse prescription order data received from a spoke Rx order at block 605. For example, a spoke Rx server 130 may forward an electronic data file containing the prescription data for a particular patient to the hub Rx server 110. A customization module 240 within hub Rx server 110 may parse the received prescription order data. The embodiments are not limited to this example.

In the illustrated embodiment shown in FIG. 6, the logic flow 600 may determine whether any physician SIG instructions (dosing instructions) are included with the received order at block 610. For example, the customization module 240 may determine whether any physician SIG instructions are included with the received order. If so, the logic flow 600 may place the physician SIG data in an HOA assignment table at block 615. Otherwise, the logic flow 600 may determine whether there are any data matches with known Product Identification Code (PIC) data at block 620. If a match is not found at block 625 the process proceeds to block 630 to assign a default dosage time. The default dosing time may be in the morning, afternoon or evening. If a match is found at block 625 the process proceeds to block 635 and the information is added to the PCDR schedule. The embodiments are not limited to this example.

In the illustrated embodiment shown in FIG. 6, the logic flow 600 may default the PCDR assignment for prescriptions without SIG or PIC associated data to an AM scheduled administration at block 630. Otherwise, the logic flow 600 may place the PIC PCDR data in the PCDR assignment table at block 635. The embodiments are not limited to this example.

In the illustrated embodiment shown in FIG. 6, the logic flow 600 may determine whether a medication may be co-mingled with other medications at block 640. If a medication cannot be co-mingled then the logic flow may proceed to block 645. If the medication can be co-mingled then the logic flow may proceed to block 650. The embodiments are not limited to this example.

In the illustrated embodiment shown in FIG. 6, the logic flow 600 may flag each medication that cannot be co-mingled as requiring a separate single medication container in the packaging at block 645. The embodiments are not limited to this example.

In the illustrated embodiment shown in FIG. 6, the logic flow 600 may determine the number of medications in the order at block 650. For example, the MMAA packaging may be capped at 16 medications administered up to four times or up to 12 times during a day. The logic flow 600 may flag each medication as AM if there are between 1 and 4 medications in the order at block 655. The logic flow 600 may flag medications 1-4 as AM and medications 5-8 as EVE if there are between 5 and 8 medications in the order at block 660. The logic flow 600 may flag medications 1-4 as AM, medications 5-8 as EVE, and medications 9-12 as NOON if there are between 9 and 12 medications in the order at block 665. The logic flow 600 may flag medications 1-4 as 8 AM, medications 5-8 as 8 PM, medications 9-12 as 12 PM, and medications 13-16 as 4 PM if there are between 13 and 16 medications in the order at block 670. Once all of the medications have been flagged by the PCDR assessment module 245 within customization engine 240 according to their hours of administration, a customized packaging sheet may be created. The customized packaging sheet may be filled by a hub pharmacy robot filler according the PCDR determination for each prescription in the order. The embodiments are not limited to this example. The PCDR schedule may be based on an analysis of the patient's activities of daily living, the prescription dosing instructions from the prescriber, the PIC codes, and or the default setting, and the number of medications assigned per dosing period. Once the primary dosing period is full, the program will assign the next set of medications to a secondary dosing period and so on. Preference may be given to the prescribers dosing instructions and/or the PIC code information.

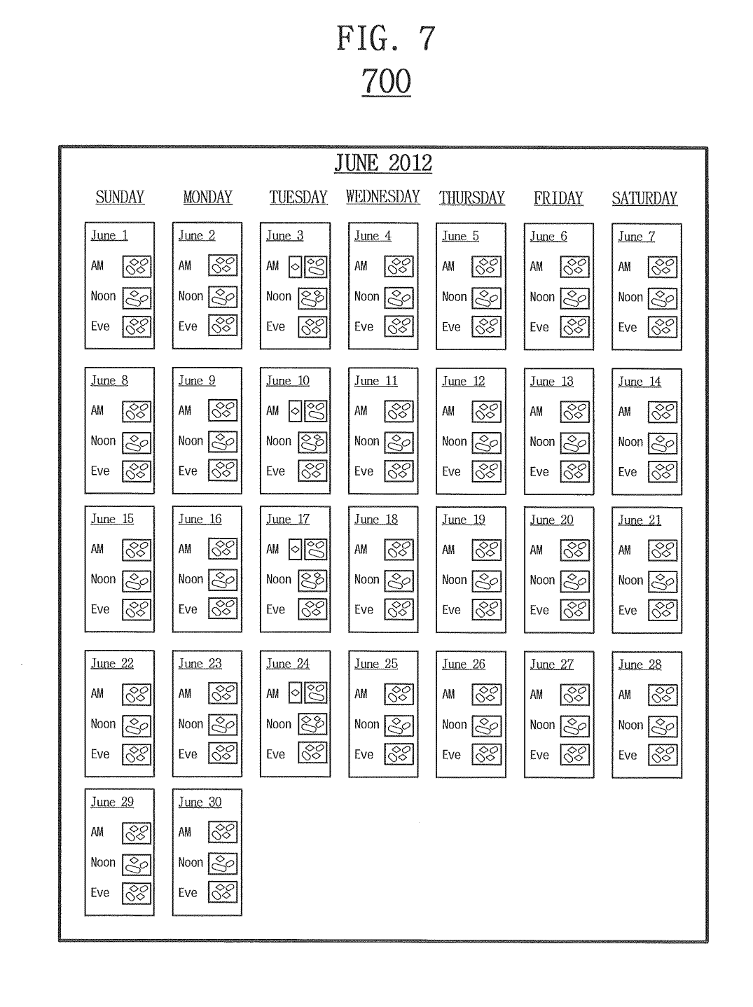

FIG. 7 illustrates an example of a customized thirty (30) day synchronized packaging 700 solution for multiple medications. The customized packaging 700 may be organized similar to a calendar. Each day of the month may be represented and include one or more pouches containing medications. The pouches may be of a blister pack type. Each pouch may be clearly labeled with an administration time to enhance adherence to a prescription regimen. In addition, the reverse side (not shown) of the customized packaging may include printed data pertaining to each medication as well as any particular physician SIG instructions or PIC data. The embodiments are not limited to this example.

In this example, twelve (12) different medications are taken by a patient over the course of the month. Eleven may be taken daily while one medication may be taken weekly (e.g., on Tuesdays). The HOA schedule scheduling process determines that for the daily medications, four may be in the morning (AM), four may be taken in the evening (EVE), and the other three may be taken mid-day (noon). The schedule may be slightly altered every Tuesday to accommodate the once weekly medication. Moreover, the once weekly medication is packaged separately as it may have been labeled as “not to be co-mingled”. To accommodate the once weekly medication, one of the morning medications may be shifted to mid-day each Tuesday so as not to exceed four medications in any given administration period in this example.

The benefits of the customized packaging are numerous. The customized packaging coordinates all of a patient's medications in a single dispensing system eliminating the need for multiple medication bottles/blisters etc. In addition, the entity that creates the customized packaging and places the medications into the medical containers performs a patient customized drug regime (PCDR) assessment to ensure that the medications are placed into the appropriate containers for ingestion at the proper time. Medications that should not be co-mingled are placed in their own separate containers and labeled accordingly. The customized packaging is designed to increase patient adherence to a recommended schedule for all prescriptions. This is accomplished by a packaging sheet or set of instructions containing a synchronized monthly supply of a patient's medications.

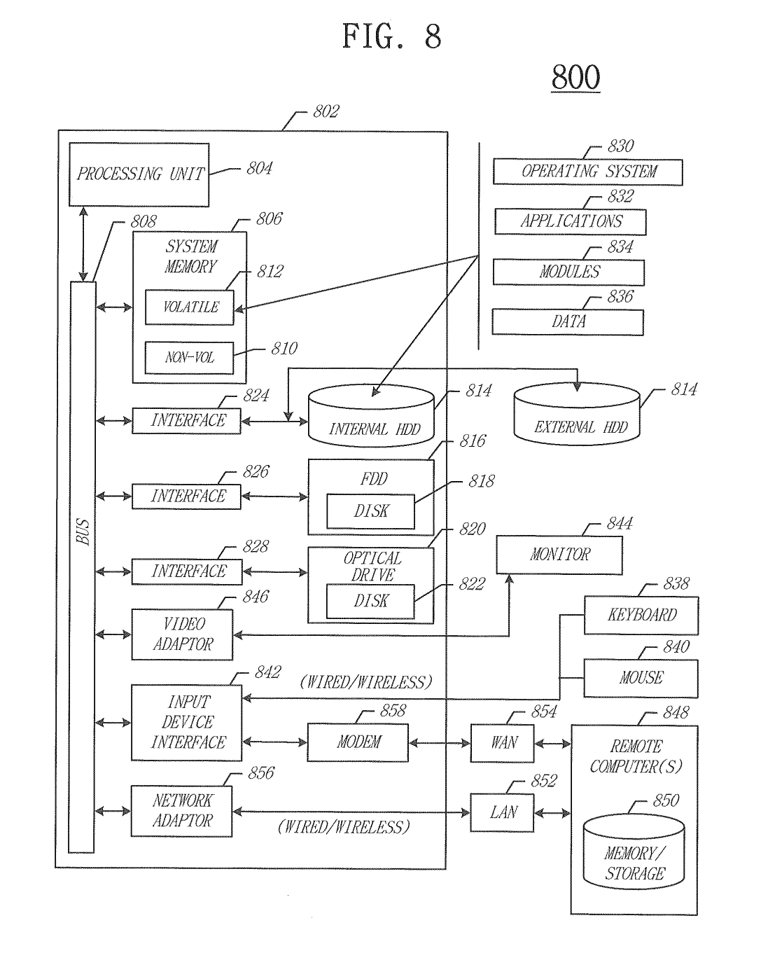

FIG. 8 illustrates an embodiment of an exemplary computing architecture 800 suitable for implementing various embodiments as previously described. In one embodiment, the computing architecture 800 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces. It is to be understood that the system may be modified to protect the patient information if so needed, by eliminating wireless transfer of information.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD®, Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, bar code scanners, smart phones, PDAs, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.15 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.15x (a, b, g, n, etc.) to provide secure, reliable, fast wireless connectivity. A Wi-Fi network can be used to connect computers to each other, to the Internet, and to wire networks (which use IEEE 802.3-related media and functions).

The invention described in the present application also covers a system having a processor component; and a patient customization engine on the processor component wherein the patient customization engine receives one or more prescription order(s) that covers medication(s) to be taken over a period of days and during one or more administration time(s), the prescription order comprising one or more prescriptions for a single patient, each prescription representative of a medication and including prescription data comprised of one or more prescriber instructions and one or more product identification code(s); determines a patient customized drug regimen (PCDR) schedule that assigns an administration time to each of the prescriptions in the prescription order over the period of days; and places the qualifying medications into the two or more medical container(s) of a customized package based on the PCDR schedule, the customized package housing all of the qualifying medications for all of the prescription orders for the period of days and comprising one or more medical container(s) for each of the one or more administration time(s) within the period of days. The packages that may be used with this system include one or more pouches, vials, blisters, boxes, ampules, nebs or a form-filled-seal-unit-dose packages, inhalers, pre-filled syringes, pens and other such medication dosing containers.

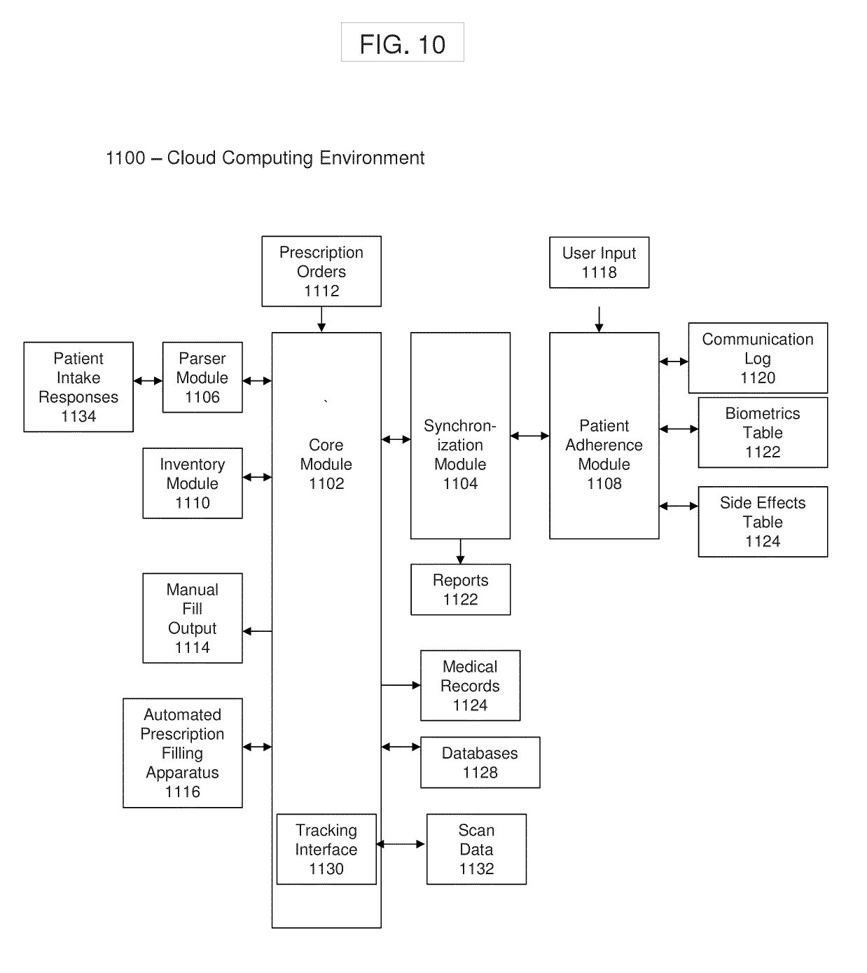

A modular system for facilitating fulfillment and patient adherence for multiple prescriptions, in some embodiments, is shown in FIG. 10. The modular system is configured as independently functioning units executing on a distributed computing system. A distributed computing system is any computing system in which processing functions and data storage are capable of being distributed among multiple units in communication with each other. In some embodiments, the distributed computing system is cloud computing environment 100% realized on the internet. Cloud computing environments are well known in the art and are not described in detail in the present application.

In some embodiments, each module is an independently executing software widget configured to perform complementary tasks in a coordinated manner to achieve specific functions as described below. In some embodiments, some or all of the functions described for any two or more modules are combined into a single module configured to perform the combined functions. In some embodiments, at least one function described for a given module is performed by a different module.

In cases in which a module or function is analogous to a component or function described in the parent application of the present application, it is understood that a module is capable of being configured to perform at least the functions as previously described. Module functions described below therefore complement those previously described. In other words, these modules may work in a sequential and/or linear order or, the modules may function in a stand-alone or independent fashion allowing the system user to pick and choose which function the user would like to run. This allows for the possibility of a customer to use the entire system or pick and choose which modules or functions the customer would like to use in its pharmacy system.

Similarly, in cases in which a feature is analogous to a feature described in the parent application of the present application, it is understood that such a feature includes all of the possible embodiments as previously described.

Core module 1102 is configured to receive one or more prescription orders 1112. In various embodiments, prescription orders 1112 are received by any combination of electronic communications and manual input. Prescription orders cover one or more medications to be taken over a period of days and during one or more administration times. Each prescription is representative of a medication and includes prescription data. Prescription data includes prescriber instructions and one or more product identification codes. The one or more prescriptions may include oral solids, lotions, inhalers, liquids, device, and/or any other form of medication prescribed to a patient by a physician.

Core module 1102 is also configured to determine a patient customized drug regimen (PCDR) schedule that assigns an administration time to each prescription in the prescription orders over the period of days.

Depending on a hold status, core module 1102 is configured to execute filling at least one of the prescriptions for a patient. In various embodiments, a hold status includes any combination of a status level for the patient and a status level for each medication represented by a prescription. In some embodiments, a patient-level hold indicates that filling is not executed for any prescription for that patient. In some embodiments, a medication-level hold indicates that filling a prescription for a specific medication for that patient is not executed. In some embodiments, a medication-level hold applies to a single patient only. In some embodiments, a medication-level hold applies to more than one patient. It is to be understood when there is a medication is a patient's order that is put on hold a user may opt to fulfill all of the medications not on hold in a patients order. The same may apply to a single patient with a hold. In other words a user may run a batch of patients from a pharmacy excluding the one or more patients with a medication level hold or a patient-level hold.

In some embodiments, executing filling at least one of the prescriptions includes filling only those prescriptions for which no holds exist. For the case in which no patient-level hold exists, prescription filling for that patient is executed for any or all of the prescriptions for which no medication-level hold exists.

In various embodiments, executing filling at least one of the prescriptions includes any combination of manual and/or automatic methods. In various embodiments, manual methods include outputting data for manually filling a prescription 1114 to a printer, a computing device, a computing network, or any apparatus capable of communicating prescription information to a technician, pharmacist, or other person.

In some embodiments, automatic methods include communicating with at least one prescription filling apparatus 1116. In various embodiments, prescription filling apparatus 1116 is a vial filling apparatus, a blister filler, a strip pack apparatus, and/or any automated or robotic prescription filling apparatus for blisters, vials, strip packs or any other similar apparatus or medication package type.

In some embodiments, communicating with prescription filling apparatus 1116 includes sending data to prescription filling apparatus 1116. In some embodiments, communicating with prescription filling apparatus 1116 also includes receiving data from prescription filling apparatus 1116.

In some embodiments, data sent to prescription filling apparatus 1116 is formatted to match an industry standard. In some embodiments, data sent to prescription filling apparatus 1116 follows a customized format. In some embodiments, data sent to prescription filling apparatus 1116 includes label information, calendar information, patient instructions, and/or PCDR information.

In some embodiments, data received from prescription filling apparatus 1116 includes medication inventory information.

In some embodiments, synchronization module 1104 is configured to receive patient profile information. In various embodiments, patient profile information includes any combination of information related to patient medical history, prescription data, insurance data, physician data, adherence data, patient-level hold information, medication-level hold information, DNA and biometric data, patient-related input by an operator, technician, pharmacist, physician, or other caregiver, or any other patient-related information.

In some embodiments, synchronization module 1104 is configured to receive information indicating changes to prescription orders. In various embodiments, changes to prescription orders include any combination of new prescriptions, canceled prescriptions, temporary prescriptions, modifications to medication dosage levels, administration times and frequency, prescription payment status, and any other prescription-related data.

In some embodiments, synchronization module 1104 is configured to receive medication anomaly information. In various embodiments, medical anomaly information includes information related to medication availability, compatibility, side-effects, prescription fulfillment issues, and any other medication-related information. In various embodiments, prescription fulfillment issues include any combination of titration requirements and special handling requirements, non-routine medications, creams, liquids, inhalers, devices and any other medication outliers.

In various embodiments, synchronization module 1104 is configured to receive information in any combination of continually, periodically, or intermittently, based on an or manually configured timing control. In various embodiments, synchronization module 1104 is configured to receive information through any combination of electronic communications, user inputs, other modules, data storage devices, computer chips, and electronic devices including portable electronic devices and/or smart devices.

In some embodiments, synchronization module 1104 is configured to determine a hold status. In various embodiments, a hold status includes any combination of a status level for the patient and a status level for each medication represented by a prescription. In some embodiments, a patient-level hold indicates that filling is not executed for any prescription for that patient. In some embodiments, a medication-level hold indicates that filling a prescription for a specific medication for that patient is not executed. In some embodiments, a medication-level hold applies to a single patient only. In some embodiments, a medication-level hold applies to more than one patient. In some embodiments a hold may be removed by technician approval, and/or pharmacist approval, and/or doctor approval.

In various embodiments, determining a hold status includes evaluating any combination of received information including patient profile information, information indicating changes to prescription orders, medication anomaly information, information indicating incompatibility between two or more medications, user inputs, stored data, and any other patient, prescription, or medication-related information from any source.

In various embodiments, determining a hold status includes receiving a hold status indication from any of another module, user input, and received information including patient profile information, information indicating changes to prescription orders, medication anomaly information, user inputs, stored data, and any other patient, prescription, device, or medication-related information from any source.

In some embodiments, synchronization module 1104 is configured to determine a production date on which to start a drug regimen schedule. In some embodiments, synchronization module 1104 is configured to determine a start date based on user input. In some embodiments, synchronization module 1104 is configured to determine a start date based on an process. In some embodiments, synchronization module 1104 is configured to determine a start date based on a combination of user input and a process. In some embodiments, synchronization module 1104 is based off of an independently determined start date entered by the technician, pharmacist, doctor, patient or a system user.

In some embodiments, determining a start date is based in part on any combination of health and financial considerations including health risks, pharmacy costs, patient copay/lifestyle risks, generic/brand name drug preferences, or other similar considerations.

In some embodiments, parser module 1106 is configured to receive patient intake responses 1134 to patient profile questions. In some embodiments, responses to patient profile questions are received from a patient intake module. In some embodiments, patient intake questions are a fixed set of questions. In some embodiments, patient intake questions are branched, with follow-up questions determined based on one or more prior responses. Patient profile questions cover any combination of medication-related topics including qualification for multi-medication customization, lifestyle, medical history, demographic data, child-resistant medication opt-out status, and any other medication-related information.

In some embodiments, parser module 1106 is configured to extract information from patient intake responses 1134. In some embodiments, the extracted information is PCDR-related information. In various embodiments, parser module 1106 uses one or more parsing engines to extract formatted data from patient intake responses 1134. Patient intake responses 1134 are provided by patients, caregivers, family members, pharmacists, technicians, physicians, insurance representatives, or other interested parties.

In some embodiments, patient adherence module 1108 is configured to provide a plurality of patient adherence questions and receive responses to the plurality of patient adherence questions. In various embodiments, patient adherence module 1108 is configured to provide and receive responses through any combination of an embedded graphical or textual user interface, computing devices, web-based interfaces, mobile electronic devices, kiosks, home health care monitoring systems, and any other apparatus for direct or indirect interfacing. In various embodiments, patient adherence module 1108 is configured to provide and receive responses to and from any combination of patients, caregivers, family members, pharmacists, technicians, physicians, insurance representatives, and any other interested parties.

In various embodiments, the plurality of patient adherence questions includes open-ended questions, closed ended-questions, medication-specific questions, lifestyle questions, side effect questions, questions related to medical history and physician and emergency room visits, accidents, sleeping habits, and any questions related to medications or combinations of medications. In some embodiments the questions are designed to be conversationalist in nature. For example, the system may prompt the user to answer one or more questions regarding specifics about an individual activity of daily living for the patient, such as “what did you eat for breakfast”, versus asking for a patient's brief summary of events such as, “are you eating.” Other types of conversation style questions may include, “how many hours did you sleep last night” or “what time did you fall asleep and what time did you wake up”, versus a summary response—“are you sleeping well”. The system is designed to prompt additional follow-up questions, based on whether any answers trigger the need for additional information. For example, if a patient says they slept three hours the prior night, the system may ask how they slept the day before to see if there is a pattern of sleep issues. In various embodiments, the system includes a regular monthly, weekly, bi-monthly or other chosen set period of time, to solicit patient information in one or more follow-up call(s) or another form of communication for one or more patients in the system. The system provides the question prompts for the user whether via smart device or via a computer station or any other device. The system is interactive with the user responses and the user input 1118 as entered into the system (as described elsewhere herein) may be actively reviewed by the system during the call as additional information is provided. The system, using the parser module 1108, scans the user input 1118 for keywords, such as health conditions or symptoms or side effects or any other chosen keyword type. The keywords identified may represent a medication issue. The system than assesses the keywords identified, compares the user input 1118 to known side effects or interactions, which may indicate potential medication incompatibility, and determines if additional questions should be asked, whether a medication-level hold or a patient-level hold should be placed on an order, and/or the severity of the type of hold to place on an order, aka what level of user is able to remove the hold.

In some embodiments, patient adherence module 1108 is configured to identify medication issues from the received responses in the form of user input 118. User input 1118 may be entered by the patient, care-giver, pharmacist, technician, doctor and/or any other system user through the computer terminal, smart device, telephone answers and manual entry by a user or any other device. In some embodiments, identifying medication issues is based on identification of a keyword of a side effect. In some embodiments, identification of a keyword of a side effect is based on a list or record of known side effects provided by one or more drug manufacturers, the Food and Drug Administration (FDA), or any similar such organization. Side effects are reported in data base files, such as and FDA database, Medi-Span, first data bank and or any other such medication side effect database. The system accesses one or more such databases, and may parse information within the database to determine a list of known side effects for a medication or combination of medications. In some embodiments, identification of a keyword of a side effect is based on prior responses received by patient adherence module 1108 and new side-effects that the system has identified for particular medications and/or combinations of one or more medications as described later herein.

In some embodiments, patient adherence module 1108 is configured to identify medication issues based in part on patient DNA profile information. In some embodiments, identification of medication issues is based on combining patient DNA profile information with medication information. Any medication issues identified by the patient adherence module 1108, based on any of the foregoing embodiments, may result in a hold on a medication and/or a patient order. Such hold may require input from the technician, pharmacist, doctor and or another system user before a medication and/or patient order may be processed. The severity of the issue will determine what level of review is required to remove the hold, with the less severe issues resulting in a hold that may be release by a technician and as the issue resulting in the hold becomes more severe, a higher level of approval may be required to remove the hold on the medication and/or the patient order, escalating to a pharmacist or a doctor for the most severe issues resulting in a hold.

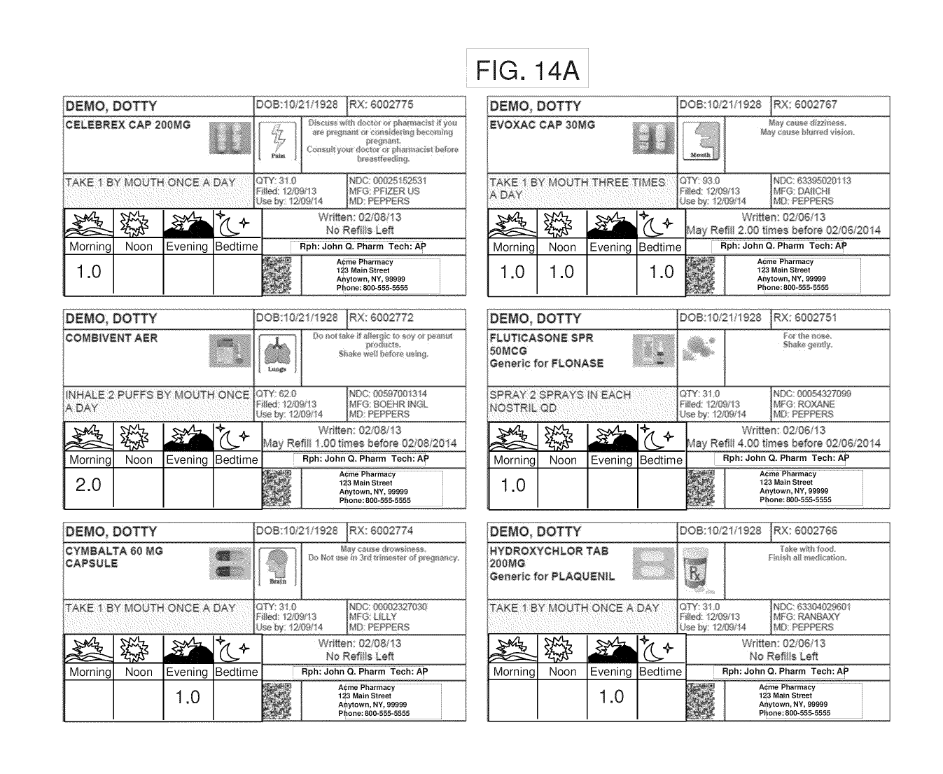

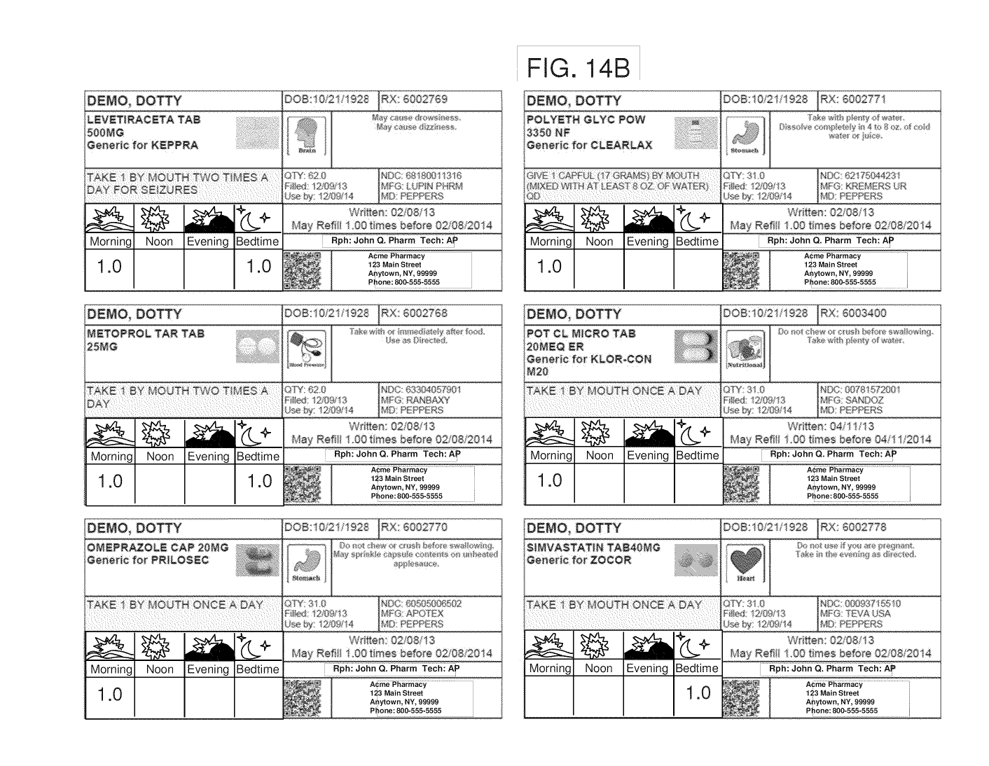

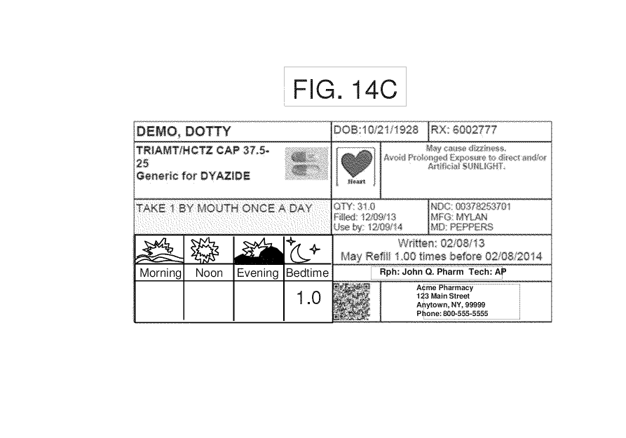

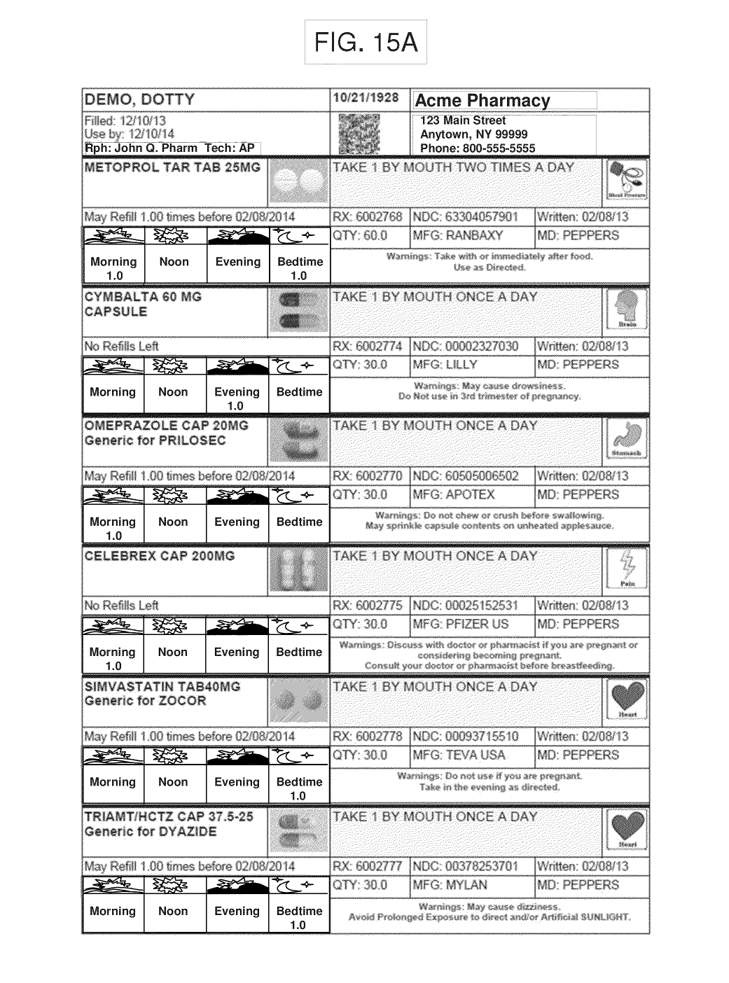

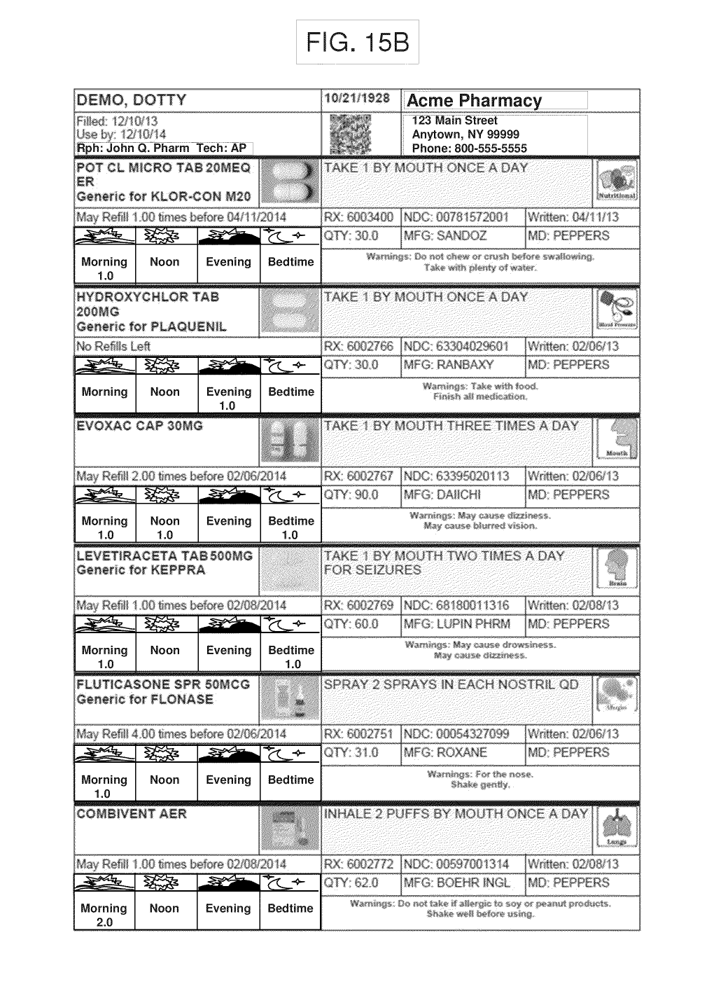

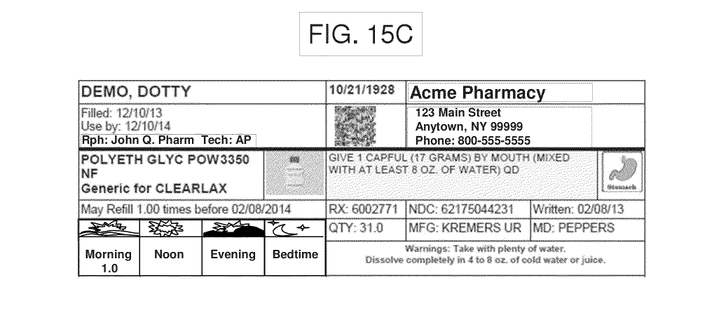

In some embodiments, patient adherence module 1108 is configured to output updated patient profile information. In various embodiments, updated patient profile information is output to any combination of core module 1102, synchronization module 1104, databases 1128, or in the form of reports 1122. Reports may be generated on one or more patients, for one or more medications, for one or more pharmacies, for one or more disease states, or for any query factors entered into the system. Reporting also may generate labels for multiple prescriptions or single prescriptions, calendars, physician sheets, patient education materials and/or delivery information. A sample patient label is set forth in FIGS. 14(a)-(c). A sample patient calendar is set forth in FIG. 15. The one or more report(s) may contain one or more types of information such as the time of day to take the medication, the disease state the medication treats, medication information, patient information, dosage information, potential side effect information and or icons or pictures indicating any of the forgoing. The one or more reports may include icons and/or words to convey information to the patient or caregiver, such as time to take medication, disease state that the medication is for (heart, lungs stomach . . . ) etc. . . . The one or more reports may use one or more colors to assist in quick identification of medication and/or dosage regimen information such as the same color used for all morning pills, a different color used for all afternoon pills, a third color used for evening pills, and/or a fourth color used for all bedtime pills. The one or more color(s) may also show up on the one or more medication pouch or package created for that dosage period to further assist with patient adherence. The one or more reports may include pictures of the one or more medications to assist the user in confirming the package has been filled correctly and/or the patient/caregiver that they are taking/providing the correct medications at the correct time. The one or more reports may also be barcoded such that additional information may be easily reached by the patient scanning a bar code associated with the dosage period and/or medication and/or medication order with a smart device and/or so the one or more reports may be scanned to confirm that the one or more reports being provided/packaged with the correct patient's medication order.

In some embodiments, patient adherence module 1108 is configured to maintain various logs. In some embodiments, logs are file-based. In some embodiments, logs are database records. In some embodiments, logs include communications log 1120 based on communications with patients, caregivers, family members, pharmacists, technicians, physicians, insurance representatives, and any other interested parties. In some embodiments, logs include biometrics table 1122 including medical record information, patient DNA information, or any other biometric-related information. In some embodiments, logs include side effects table 1124 including any combination of side effect information related to medications and response to the plurality of patient profile questions.

In some embodiments, patient adherence module 1108 is configured to identify medication issues based at least in part on the information in side effects table 1124. In various embodiments, patient adherence module 1108 is configured to identify medication issues based any combination of information in side effects table 1124 for a single patient, multiple patients, single medication, and combinations of medications.

In various embodiments, patient adherence module 1108 is configured to identify side effect issues based on any combination of number or percentage of responses indicating a possible side effect issue for one or more medications or one or more medication combinations. In various embodiments user input 1118 is entered into a log and new side effects identified for one or more medications and/or medication combinations once a pre-determined number of patients have reported similar side effects. The system includes these new “learned” side effects into the side effects table for one or more medications or combinations of one or more medications and once identified the system used in follow-up communication with patients to determine whether based on a patient's response(s) to the system's questions, whether a hold should be placed on one or more patient medications and/or one or more medication order(s). The number of patients having side effects or drug interaction symptoms required to create a new system recognized side effect or interaction may be up to 10 patients, 15 patients, 20 patients, 50 patients, 100 patients and/or any chosen number assigned to the system. The system may alert the user when a new side effect or drug interaction is identified for one or more medication(s) and/or medication combinations. The system may also alert or communicate with one or more internal or external side effect databases or drug interaction databases.

In some embodiments, identification of a medical issue is used to determine a hold status. In some embodiments, a user input is used to determine a hold status. In various embodiments, a hold status includes any combination of a status level for the patient and a status level for each medication represented by a prescription.

In some embodiments, patient adherence module 1108 is configured to initiate communications to obtain updated patient profile information. Communications are initiated in any combination of periodically and intermittently. In some embodiments, patient adherence module 1108 is configured to initiate communications monthly.

In some embodiments, core module 1102 includes tracking interface 1130. In various embodiments, tacking interface 1130 is configured to bilaterally communicate scan data 1132 with tracking devices (not shown). In various embodiments, scan data includes data collected via any combination of bar code readers, biometric devices, RFID transponders, and any other device capable of collecting and communicating scan data.

In various embodiments, scan data includes any combination of data used to identify medications, labels, packaging, manifests, technicians, pharmacists, or any other entity associated with prescription fulfillment.

In some embodiments, core module 1102 is configured to communicate bilaterally with one or more databases 1128. In various embodiments, one or more data bases 1128 are any combination of local, server-based, and cloud-based database applications. In some embodiments, one or more databases 1128 are hosted on an HIPAA-compliant server farm. In various embodiments, on or more databases store any combination of patient profile, patient adherence, medication, medical record, biometric, DNA, side effect, pharmacy, billing, or physician information, scan data, and any other patient or medication-related information. The system may track a prescription order and each system user's interaction with that order as the order progresses through the system, by scanning when a user performs a task or function at any point during the prescription order process.

In some embodiments, core module 1102 is configured to output medical records 1124. In various embodiments, medical records include any combination of electronic medical records, electronic health records, electronic medication administration records, and any other medical record format.

In some embodiments, synchronization module 1104 is configured to output reports 1122. In various embodiments, reports 1122 includes any combination of report topics including adherence, outcomes, monthly fill data, calendars, labels, manifests, physician reporting, inventory reporting, and any other topic related to patient and medication information.

In some embodiments, inventory module 1110 is configured to communicate bilaterally with core module 1102. In some embodiments, inventory module is configured to monitor medication availability.

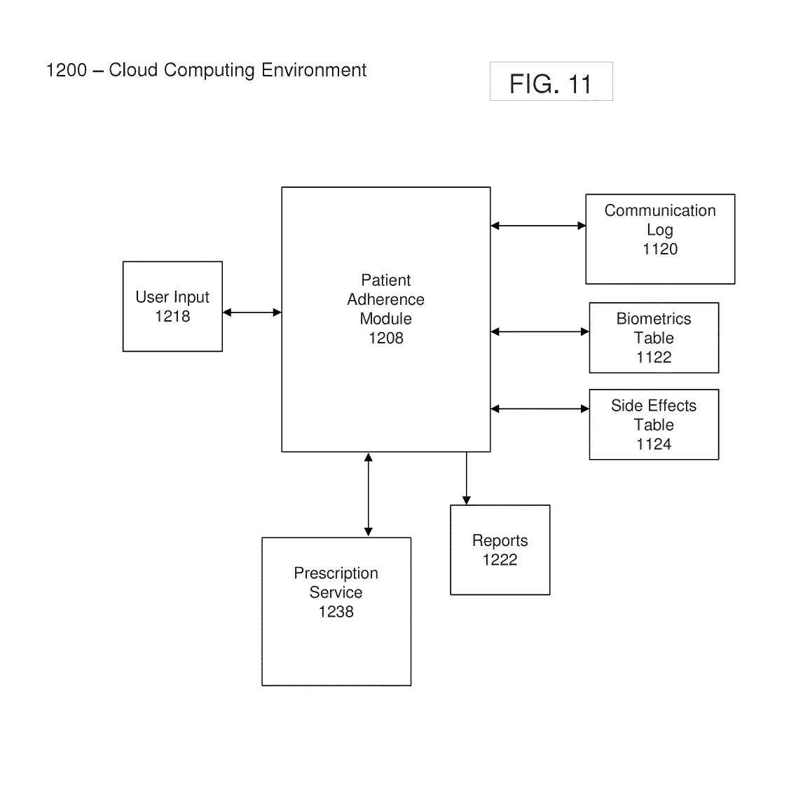

Referring to FIG. 11, in some embodiments, patient adherence module 1208 is configured to execute independently from other modules as a stand-alone application. Patient adherence module 1208 includes at least all of the features set forth above for patient adherence module 1108.

As in the preceding description for patient module 1108, patient adherence module 1208 is implemented in cloud computing environment 1200 equivalent to cloud computing environment 1100, and configured to receive user input 1218 equivalent to user input 1118, maintain communication log 1120, biometrics table 1122, and side effects table 1124, output reports 1222 equivalent to reports 1122. In some embodiments, patient adherence module 1208 is configured to communicate bilaterally with prescription service 1238. In various embodiments. Prescription service 1238 is any prescription medication service system capable of sending and receiving data related to patient adherence.

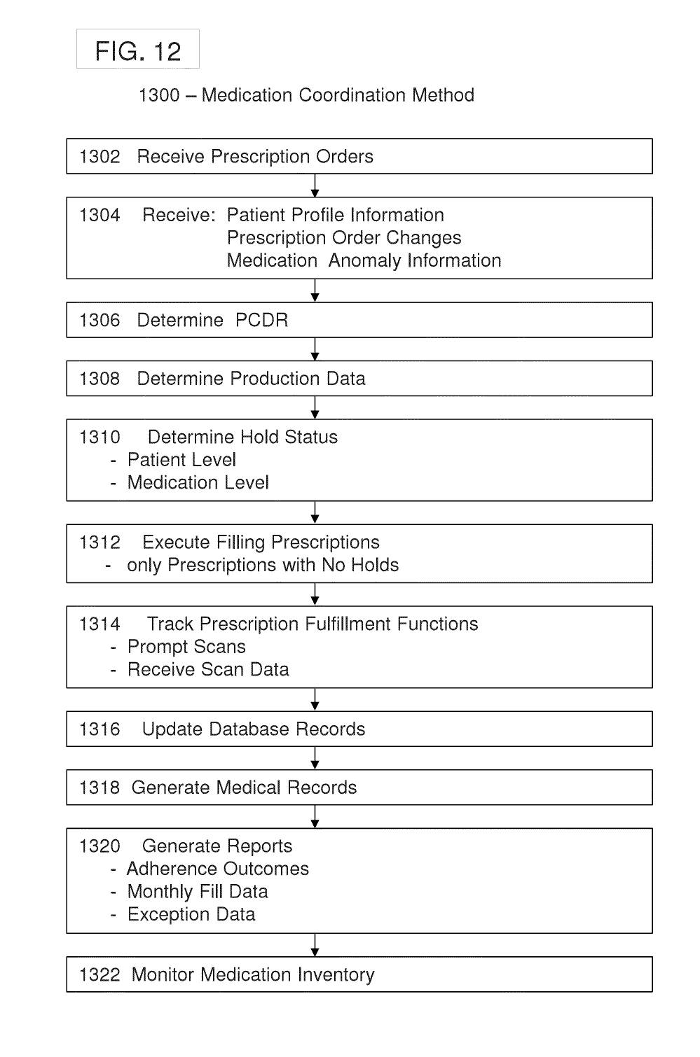

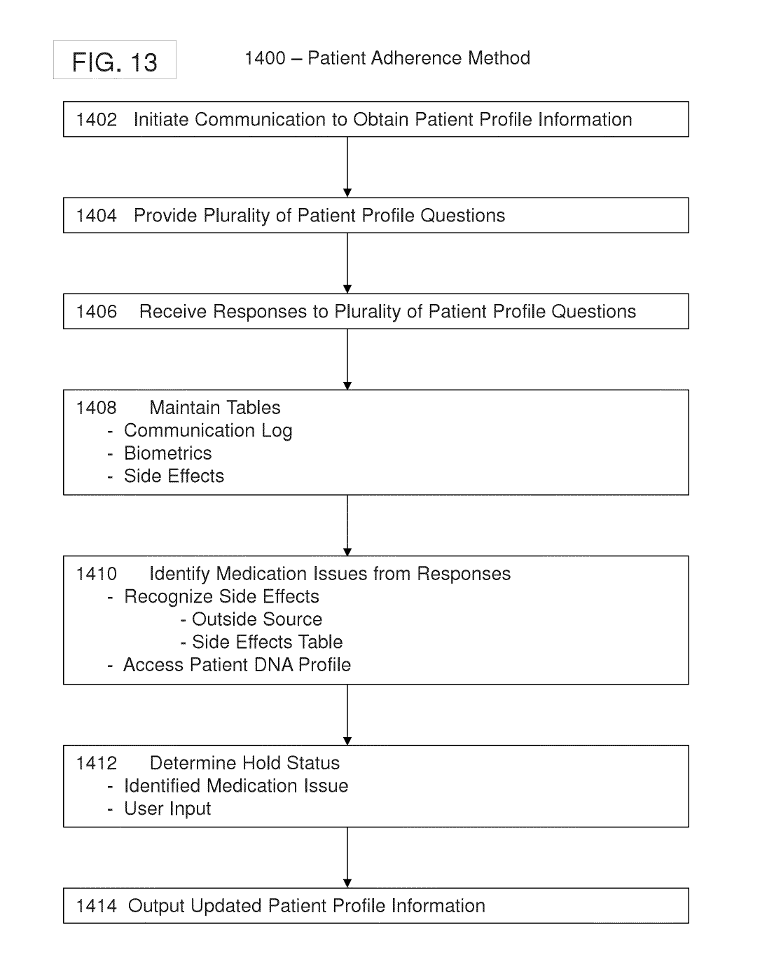

FIG. 12 is a flow chart of a method 1300 of medication coordination implemented on a distributed computing environment in accordance with one or more embodiments such as the system depicted in FIG. 10. In various embodiments, any of the steps represented in FIG. 12 may be omitted or executed an order other than that depicted.

At step 1302, one or more prescription orders are received, a prescription order comprising one or more prescriptions for a single patient over a period of days.

At step 1304, one or more of patient profile, prescription order change, and medication anomaly information is received. In various embodiments, patient profile information includes any combination of information related to patient medical history, prescription data, insurance data, physician data, adherence data, patient-level hold information, medication-level hold information, DNA and biometric data, patient-related input by an operator, technician, pharmacist, physician, or other caregiver, or any other patient-related information.

In various embodiments, changes to prescription orders include any combination of new prescriptions, canceled prescriptions, temporary prescriptions, modifications to medication dosage levels, administration times and frequency, prescription payment status, patient status, patient discharge information, and any other prescription or patient-related data.

In various embodiments, medical anomaly information includes information related to medication availability, compatibility, side-effects, prescription fulfillment issues, and any other medication-related information. In various embodiments, prescription fulfillment issues and any other medication or device related information include any combination of titration requirements and special handling information, non-routine medications, creams, liquids, inhalers, and any other medication outliers.

At step 1306, a PCDR schedule is determined that assigns an administration time for each of the prescriptions in the prescription order over the period of days. In various embodiments, medical anomaly information includes information related to medication availability, compatibility, side-effects, prescription fulfillment issues, and any other medication-related information. In various embodiments, prescription fulfillment issues include any combination of titration requirements, special handling requirements, special dosing requirements, of routine, non-routine medications or medication devices, creams, liquids, inhalers, specialty medications, compounded medications, over the counter medications, and any other medication outliers.

At step 1308, a production date is determined. On which to start or stop a drug regimen schedule. In some embodiments, determining a start or stop date is based on user input. In some embodiments, determining a start or stop date is based on an automated process. In some embodiments, determining a start or stop date is based on a combination of user input and an automated process. In some cases a start of stop date is based on a medication related or healthcare related event otherwise reported from an external feed from an electronic medical record, electronic health record, prescribe service, or any other electronic data feed that is deemed appropriate for reporting said events. In some embodiments, a start date is determined independently by the user.

At step 1310, a hold status is determined. In various embodiments, a hold status includes any combination of a status level for the patient and a status level for each medication represented by a prescription.

At step 1312, depending on a hold status, filling at least one of the prescriptions for the single patient is executed. In various embodiments, executing filling a prescription includes any combination of outputting data for manual subscription fulfillment and communicating with at least one prescription filling apparatus.

At step 1314, prescription fulfillment functions are tracked. In various embodiments, tracking prescription fulfillment functions includes any combination of sending data to prompt scans by one or more scanning devices and receiving scan data from one or more scanning devices. In various embodiments, scan data includes any combination of data used to identify medications, labels, packaging, manifests, technicians, pharmacists, or any other entity associated with prescription fulfillment.

At step 1316, database records are updated. In various embodiments, on or more database records store any combination of patient profile, patient adherence, medication, medical record, biometric, DNA, side effect, pharmacy, billing, or physician information, scan data, and any other patient or medication-related information.

At step 1318, medical records or pharmacy records are generated. In various embodiments, medical records or pharmacy records include any combination of electronic medical records, electronic health records, electronic medication administration records, and any other medical record format

At step 1320, reports are generated. In various embodiments, reports includes any combination of report topics including adherence, outcomes, monthly fill data, calendars, labels, manifests, physician reporting, inventory reporting, and any other topic related to patient and medication information.

At step 1322, Medication inventory is monitored.

FIG. 13 is a flow chart of a method 1400 of medication adherence implemented on a distributed computing environment in accordance with one or more embodiments such as the module depicted in FIG. 2. In various embodiments, any of the steps represented in FIG. 13 may be omitted or executed an order other than that depicted.

At step 1402, communication is initiated to obtain updated patient profile information. Communications are initiated in any combination of periodically and intermittently. In some embodiments, communications are initiated monthly.

At step 1404, a plurality of patient profile questions is provided, and at step 1406, responses to the plurality of patient profile questions are received. In various embodiments, providing and receiving responses is through any combination of an embedded graphical or textual user interface, computing devices, web-based interfaces, mobile electronic devices, kiosks, home health care monitoring systems, and any other apparatus for direct or indirect interfacing. In various embodiments, patient adherence module 1108 is configured to provide and receive responses to and from any combination of patients, caregivers, family members, pharmacists, technicians, physicians, insurance representatives, and any other interested parties.

At step 1408, tables are maintained. In some embodiments, tables include communications logs based on communications with patients, caregivers, family members, pharmacists, technicians, physicians, insurance representatives, and any other interested parties. In some embodiments, tables include biometrics tables including medical record information, patient DNA information, or any other biometric-related information. In some embodiments, tables include side effects tables including any combination of side effect information related to medications and response to the plurality of patient profile questions.

At step 1410, medication issues are identified from responses to the plurality of patient profile questions. In some embodiments, identifying medication issues is based on identification of a keyword of a side effect. In some embodiments, identification of a keyword of a side effect is based on a list or record of known side effects provided by one or more drug manufacturers, the Food and Drug Administration (FDA), or any similar such organization. In some embodiments, identification of a keyword of a side effect is based on prior responses received.

In some embodiments, medication issues are identified at least in part on the information in one or more side effects tables. In various embodiments, medication issues are identified based any combination of information in side effects tables for a single patient, multiple patients, single medication, and combinations of medications.

In various embodiments, patient adherence module 1108 is configured to identify side effect issues based on any combination of number or percentage of responses indicating a possible side effect issue.

In some embodiments, medication sensitivities, side effects, rate of metabolization, proper dosage, potential adverse drug events, and other issues are identified in part on patient DNA profile information. In some embodiments, identification of medication sensitivities, side effects, rate of metabolization, proper dosage, potential adverse drug events, and other issues is based on combining patient DNA profile information with medication and device information.

At step 1412, a hold status is determined. In some embodiments, identification of a medication related event, adverse drug reaction, or medical issue is used to determine a hold status. In some embodiments, a user input is used to determine a hold status. In various embodiments, a hold status includes any combination of a status level for the patient and a status level for each medication represented by a prescription.

At step 1414, updated patient profile information is output. In various embodiments, updated patient profile information is output to any combination of systems and databases or in the form of reports.

FIGS. 14(a)-(c) show sample patient prescription order labels.

FIGS. 15(a)-(c) show other sample patient prescription order labels.

FIG. 16 shows a sample patient prescription calendar.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A system implemented in a distributed computing environment, the system comprising:
a core module configured to:
receive a prescription order that covers one or more medications to be taken over a period of days and during one or more administration times, the prescription order comprising one or more prescriptions for a single patient, each prescription representative of a medication and including prescription data comprised of one or more prescriber instructions and one or more product identification codes;
determine a patient customized drug regimen (PCDR) schedule that assigns an administration time to each of the prescriptions in the prescription order over the period of days;
depending on a hold status, execute filling at least one of the prescriptions for the single patient; and
a synchronization module configured to:
receive one or more of patient profile information, information indicating at least one change to the prescription order, and medication anomaly information;
determine the hold status.

2. The system of claim 1, wherein the distributed computing environment is a cloud computing environment.

3. The system of claim 1, wherein determining the hold status is based at least in part on the received patient profile information.

4. The system of claim 1, wherein determining the hold status is based at least in part on the received information indicating changes to the prescription order.

5. The system of claim 4, wherein the received information indicating at least one change to the prescription order comprises a new prescription for the single patient.

6. The system of claim 1, wherein determining the hold status is based at least in part on the medication anomaly information.

7. The system of claim 1, wherein determining the hold status is based at least in part on compatibility between two or more medications.

8. The system of claim 1, wherein the hold status comprises a status level for the single patient.

9. The system of claim 1, wherein the hold status comprises a status level for a single medication.

10. The system of claim 1, wherein executing filling at least one of the prescriptions for the single patient comprises outputting data for manually filling the at least one of the prescriptions.

11. The system of claim 1, wherein executing filling at least one of the prescriptions for the single patient comprises communicating with at least one prescription filling apparatus.

12. The system of claim 1, wherein the synchronization module is further configured to automatically determine a production date to start the period of days.

13. The system of claim 1, further comprising a parser module configured to:
receive responses to patient profile questions;
extract PCDR-related information from the responses; and
send the PCDR-related information to the core module.

14. The system of claim 1, further comprising a patient adherence module configured to:
provide a plurality of patient profile questions;
receive responses to the plurality of patient profile questions;
identify medication issues from the responses; and
output updated patient profile information.

15. The system of claim 14, wherein identifying medication issues from the responses comprises recognizing a side effect.

16. The system of claim 14, wherein identifying medication issues from the responses comprises accessing a patient DNA profile.

17. The system of claim 14, wherein the patient adherence module is further configured to maintain at least one of a communication log, medication history table, indications table, a biometrics table, or a side effects table.

18. The system of claim 17, wherein identifying medication issues from the responses comprises recognizing a side effect based on the side effects table.

19. The system of claim 14, wherein the patient adherence module is further configured to determine the hold status based on at least one of an identified medical issue, potential medication incompatibility, or user input.

20. The system of claim 14, wherein the patient adherence module is further configured to initiate communications to obtain updated patient profile information.

21. The system of claim 20, wherein the communications are initiated periodically.

22. The system of claim 21, wherein the communications are initiated monthly.

23. The system of claim 14, wherein outputting updated patient profile information comprises outputting data to the synchronization module.

24. The system of claim 1, wherein the core module further comprises a tracking interface configured to bilaterally communicate scan data indicative of prescription fulfillment functions.

25. The system of claim 1, wherein the core module is further configured to bilaterally communicate with one or more databases.

26. The system of claim 1, wherein the core module is further configured to output medical records.

27. The system of claim 1, wherein the synchronization module is further configured to generate reports for at least one of adherence outcomes, monthly fill data, and exception data for multiple patients.

28. The system of claim 1, further comprising an inventory module configured to monitor medication availability.

29. A patient adherence module implemented in a distributed computing environment, the patient adherence module configured to:
provide a plurality of patient profile questions;
receive responses to the plurality of patient profile questions;
identify medication issues from the responses; and
output updated patient profile information.

30. The patient adherence module of claim 29, wherein identifying medication issues from the responses comprises recognizing a side effect.

31. The patient adherence module of claim 29, wherein identifying medication issues from the responses comprises accessing a patient DNA profile.

32. The patient adherence module of claim 29 wherein the patient adherence module is further configured to maintain at least one of a communication log, a biometrics table, or a side effects table.

33. The patient adherence module of claim 32, wherein identifying medication issues from the responses comprises recognizing a side effect based on the side effects table.

34. The patient adherence module of claim 29 wherein the patient adherence module is further configured to determine a hold status based on at least one of an identified medical issue or user input.

35. The patient adherence module of claim 29, wherein the patient adherence module is further configured to initiate communications to obtain updated patient profile information.

36. The patient adherence module of claim 35, wherein the communications are initiated periodically.

37. The patient adherence module of claim 36, wherein the communications are initiated monthly.

38. The patient adherence module of claim 29 wherein outputting updated patient profile information comprises outputting data to at least one database.

39. A method implemented on a computing system, the method comprising:
receiving a prescription order that covers one or more medications to be taken over a period of days and during one or more administration times, the prescription order comprising one or more prescriptions for a single patient, each prescription representative of a medication and including prescription data comprised of one or more prescriber instructions and one or more product identification codes;
receiving one or more of patient profile information, information indicating at least one change to the prescription order, and medication anomaly information;
determining a patient customized drug regimen (PCDR) schedule that assigns an administration time to each of the prescriptions in the prescription order over the period of days;
determining a hold status; and
depending on the hold status, executing filling at least one of the prescriptions for the single patient.

40. The method of claim 39, wherein the distributed computing environment is a cloud computing environment.

41. The method of claim 39, wherein determining the hold status is based at least in part on the received patient profile information.

42. The method of claim 39, wherein determining the hold status is based at least in part on the received information indicating changes to the prescription order.

43. The method of claim 42, wherein the received information indicating at least one change to the prescription order comprises a new prescription for the single patient.

44. The method of claim 39, wherein determining the hold status is based at least in part on the medication anomaly information.

45. The method of claim 39, wherein determining the hold status is based at least in part on compatibility between two or more medications.

46. The method of claim 39, wherein the hold status comprises a status level for the single patient.

47. The method of claim 39, wherein the hold status comprises a status level for a single medication.

48. The method of claim 39, wherein executing filling at least one of the prescriptions for the single patient comprises outputting data for manually filling the at least one of the prescriptions.

49. The method of claim 39, wherein executing filling at least one of the prescriptions for the single patient comprises communicating with a prescription filling apparatus.

50. The method of claim 39, further comprising automatically determining a production date to start the period of days.

51. The method of claim 39, further comprising bilaterally communicating to obtain scan data indicative of prescription fulfillment functions.

52. The method of claim 39, further comprising updating one or more databases.

53. The method of claim 39, further comprising outputting medical records.

54. The method of claim 39, further comprising generating reports for at least one of adherence outcomes, monthly fill data, and exception data for multiple patients.

55. The method of claim 39, further comprising monitoring medication availability.

56. A method implemented on a computing system, the method comprising:
providing a plurality of patient profile questions;
receiving responses to the plurality of patient profile questions;
identifying medication issues from the responses; and
outputting updated patient profile information.

57. The method of claim 56, wherein identifying medication issues from the responses comprises recognizing one of a medication side effect or a drug interaction.

58. The method of claim 56, wherein identifying medication issues from the responses comprises accessing a patient DNA profile.

59. The method of claim 56, further comprising maintaining at least one of a communication log, a biometrics table, or a side effects table.

60. The method of claim 59, wherein identifying medication issues from the responses comprises recognizing a side effect based on the side effects table.

61. The method of claim 56, further comprising determining a hold status based on at least one of an identified medical issue or user input.

62. The method of claim 56, further comprising initiating communications to obtain updated patient profile information.

63. The method of claim 62, wherein the communications are initiated periodically.

64. The method of claim 63, wherein the communications are initiated monthly.

65. The method of claim 56, wherein outputting updated patient profile information comprises outputting data to one or more databases.

66. A method implemented on a computing system, the method comprising:
providing a plurality of patient profile questions;
receiving responses to the plurality of patient profile questions;
identifying medication issues from the responses; and
collecting the medication issues in one or more log(s).

67. The method of claim 66 further comprising, analyzing the medication issues in the one or more log(s), determining when 10 or more patients taking the same medication are reporting one or more of the same medication issues, and identifying the medication issue as a new medication issue associated with the medication the 10 or more patients were taking

68. The method of claim 67 further comprising reporting the new medication issue as being associated with the medication the 10 or more patients were taking to one of an external database or an internal database.

69. The method of claim 66 further comprising, analyzing the medication issues in the one or more log(s), determining when 10 or more patients taking the two or more of the same medication(s) are reporting one or more of the same medication issues, and identifying the medication issue as a new medication issue associated with the two or more medication(s) the 10 or more patients were taking
70. The method of claim 69 further comprising reporting the new medication issue as being associate with the two or more medications the 10 or more patients were taking to one of an external database or an internal database.
